(19) United States
(12) Patent Application Publication
(10) Pub. No.: US 2026/0290063 A1
(43) Pub. Date: Sep. 24, 2026

(54) SYSTEM

(71) Applicant: SoftBank Group Corp., Tokyo (JP)

(72) Inventor: Shoya KUSUNOSE, Tokyo (JP)

(73) Assignee: SoftBank Group Corp., Tokyo (JP)

(21) Appl. No.: 19/565,550

(22) Filed: Mar. 13, 2026

(30) Foreign Application Priority Data
Mar. 19, 2025 (JP) 2025-045145

(51) Int. Cl. G06V 30/414; G06F 16/3329; G06F 16/338; G06F 40/30

(52) U.S. Cl. CPC G06V 30/414; G06F 16/33295; G06F 16/338; G06F 40/30

(57) ABSTRACT

A system includes a processor that is configured to input a prompt to a generative AI model to instruct the generative AI model to perform an analysis of contents of a paper using natural language processing techniques and to obtain an analysis result generated by the generative AI model, calculate a relevance score for each of a plurality of references based on the analysis result, select, as contextually citable references, references having a relevance score equal to or greater than a predetermined threshold, recognize an emotion of a user, and adjust the analysis result based on the recognized emotion of the user.

### CROSS-REFERENCE TO RELATED APPLICATION

This application is based on and claims priority under 35 USC 119 from Japanese Patent Application No. 2025-045145 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional academic writing support systems, processors typically analyze the contents of a paper using rule-based or statistical natural language processing techniques and then search for references that are textually similar to the paper. However, such systems suffer from several problems. First, the analysis of the paper's contents is often shallow and lacks the ability to capture nuanced context, intent, and latent topics, which leads to selection of references that are only superficially related. Second, relevance scoring for references is generally limited to keyword matching and bibliographic filters, and therefore fails to reliably identify references that are truly contextually citable in view of the author's actual argument and contribution. Third, existing systems generally treat all users in a uniform manner and do not take into account the emotional state or cognitive load of the user, such as frustration, uncertainty, or confidence, during the writing process. As a result, the presentation and adjustment of analysis results may not match the user's emotional condition, which can reduce usability and satisfaction, and may even cause the user to overlook important references. Accordingly, there is a need for a system that uses a generative AI model to perform deeper natural language processing analysis of a paper, that selects references based on a contextually meaningful relevance score, and that recognizes and reflects a user's emotion in the adjustment of analysis results, thereby improving the quality and user-friendliness of reference recommendation.

### SUMMARY

In order to solve the above-described problems, a system according to one aspect of the present invention comprises a processor configured to input a prompt to a generative AI model to instruct the generative AI model to perform an analysis of contents of a paper using natural language processing techniques and to obtain an analysis result generated by the generative AI model. By delegating the analysis of the paper to the generative AI model through the prompt, the processor enables context-aware, semantic, and flexible interpretation of the paper's subject, structure, and key concepts. The processor is further configured to calculate a relevance score for each of a plurality of references based on the analysis result and to select, as contextually citable references, references having a relevance score equal to or greater than a predetermined threshold. Through this relevance score calculation, the processor can automatically filter and prioritize references that exhibit high contextual relevance to the analyzed paper. In addition, the processor is configured to recognize an emotion of a user and to adjust the analysis result based on the recognized emotion of the user, for example by modifying thresholds, presentation style, or emphasis within the analysis result in response to the user's emotional state. By these means, the system provides emotionally adaptive, contextually accurate reference recommendations derived from generative AI-based analysis of the paper's contents.

The term “system” refers to an arrangement comprising at least one processor and, optionally, one or more memories, input/output interfaces, and communication interfaces, the arrangement being configured to execute the functions described in the claims.

The term “processor” refers to any hardware device or combination of hardware devices, such as a CPU, GPU, ASIC, FPGA, or microcontroller, that is capable of executing instructions to perform logical and arithmetic operations and to control other components of the system.

The term “generative AI model” refers to a machine-learned model, such as a large language model or other generative neural network, that is configured to generate or transform text or other content in response to an input, including prompts, and that performs natural language processing based on learned parameters.

The term “prompt” refers to data including text or other symbols that is input to the generative AI model to instruct the generative AI model to perform a specific processing task, such as analyzing contents of a paper.

The term “contents of a paper” refers to textual information constituting at least a part of an academic or technical document, including, for example, a title, abstract, introduction, body text, figures or tables descriptions, and conclusions.

The term “natural language processing techniques” refers to computational methods for analyzing and processing human language text, including but not limited to tokenization, parsing, semantic analysis, topic modeling, embedding generation, and information extraction.

The term “analysis result” refers to information generated by the generative AI model in response to the prompt, the information including at least one of extracted topics, keywords, contextual representations, summaries, or other structured or unstructured data representing the contents of the paper.

The term “reference” refers to an external document or information source, such as an academic paper, conference proceeding, book, patent document, or web article, that can be cited in the paper.

The term “plurality of references” refers to two or more references that are candidates for citation in the paper.

The term “relevance score” refers to a numerical or ordinal value calculated by the processor based on the analysis result and metadata or content of each reference, the value representing a degree of contextual relatedness between the contents of the paper and the reference.

The term “predetermined threshold” refers to a previously defined fixed value or a value determined according to a rule or parameter, the value being used as a criterion to decide whether the relevance score of a reference is sufficient for selection.

The term “contextually citable reference” refers to a reference whose relevance score is equal to or greater than the predetermined threshold and that is considered appropriate to be cited in the paper in view of the context of the contents of the paper.

The term “user” refers to a person, such as an author or editor of a paper, who operates a terminal or other device to use the system.

The term “emotion of a user” refers to an emotional state of the user, including, for example, states such as satisfaction, dissatisfaction, frustration, confusion, confidence, or interest, which is recognized by the system.

The term “recognize an emotion of a user” refers to a processing operation in which the processor determines or estimates the emotion of the user based on at least one of user input, behavioral data, physiological data, or interaction history.

The term “adjust the analysis result based on the recognized emotion” refers to a processing operation in which the processor modifies the analysis result or a presentation of the analysis result, such as by changing emphasis, detail level, filtering criteria, or ranking, in response to the recognized emotion of the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

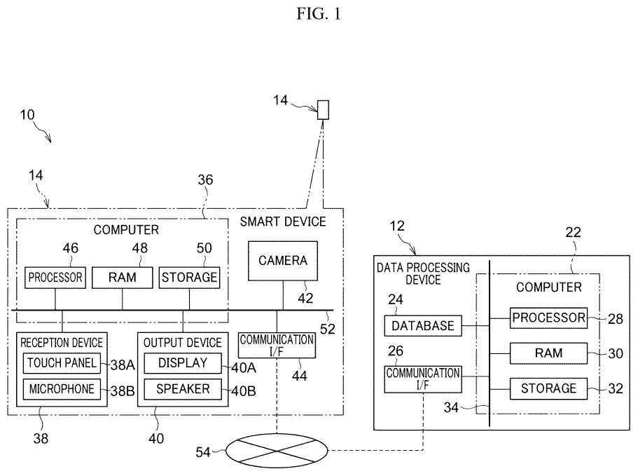

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

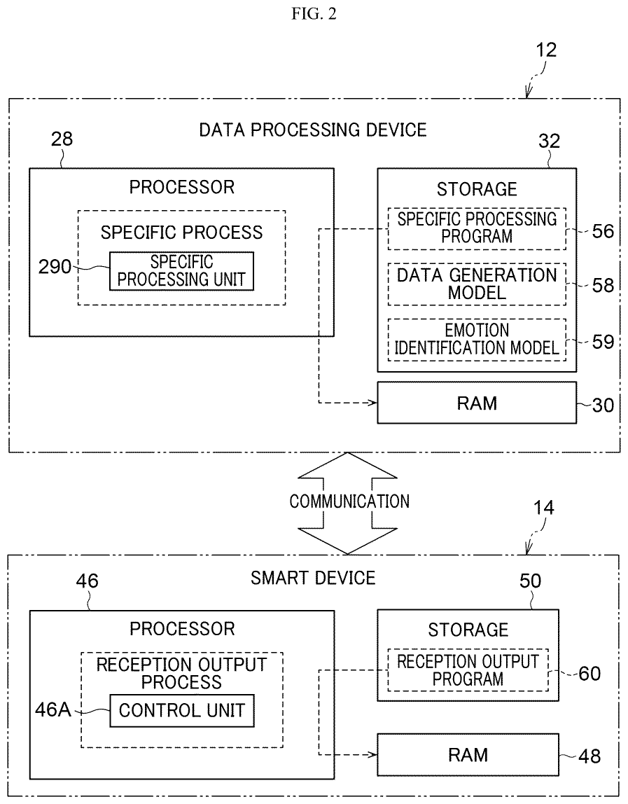

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional document analysis and recommendation systems suffer from several technical limitations when implemented on general-purpose computing hardware. First, such systems typically rely on static keyword matching or simple statistical techniques that operate on unstructured text, without deeply integrating outputs from both deterministic natural language processing engines and generative AI models. As a result, topic extraction, context understanding, and resource selection are often inaccurate or incomplete, which leads to low-quality search queries and suboptimal recommendations.

Second, existing systems generally treat relevance estimation and usage-frequency information as separate or loosely coupled processes. Recommendation engines frequently compute similarity scores based solely on document content or user profiles, and usage logs such as access counts or viewing times are used only for coarse popularity metrics. This disjoint handling of semantic relevance and time-normalized usage signals prevents the computing system from effectively ranking resources in a way that reflects both technical pertinence and real-world utility, thereby limiting the practical value of the system for users.

Third, generative AI models are often invoked in an ad hoc manner, for example to summarize a document or to answer questions, without a structured integration into the underlying retrieval and ranking pipeline. Prompt sentences are commonly hand-crafted or static, and are not dynamically constructed from machine-readable analysis data, resource metadata, and user-specific attributes. Consequently, responses from the generative AI model are not tightly aligned with the internal state of the system, and are difficult to use as reliable signals for refining recommendation logic or adjusting explanations at scale.

Fourth, known systems do not adequately optimize the internal flow of data and control between the document ingestion pipeline, the natural language processing engine, the search and ranking subsystem, and the generative AI model. For example, text normalization, feature vector generation, and prompt construction are often implemented in separate components without a coherent orchestration. This causes redundant computation, increased latency, and inconsistent representations of document semantics across different modules, thereby degrading the overall computational efficiency and responsiveness of the system.

Fifth, many systems do not systematically generate machine-oriented feature vectors and human-oriented prompt sentences from a common analysis result in a way that is tailored to the capabilities and input constraints of both traditional search engines and generative AI models. Without such coordinated generation, the computing system cannot fully exploit high-dimensional feature spaces for similarity search while simultaneously providing rich, context-aware prompts that guide the generative AI model to produce targeted, verifiable outputs.

The technical problem addressed by the present invention is therefore to improve computer technology in the field of document analysis and recommendation by providing: (i) a coordinated processing architecture that normalizes and structurally analyzes document text; (ii) an integrated mechanism that combines deterministic natural language processing outputs with generative AI responses; (iii) a unified ranking framework that jointly leverages content-based relevance and temporally normalized usage-frequency metrics; and (iv) a dynamic prompt generation mechanism that uses internal analysis data, resource information, and user attributes to control a generative AI model so as to refine recommendations and explanations. By solving these problems at the system and data-flow level, the invention improves the functioning of the computer itself, resulting in more accurate, efficient, and context-aware document recommendation processing on general-purpose hardware.

The specific processing by the specific processing unit 290 of the data processing device 12 in Example 1 is realized by the following means.

The present invention provides a server comprising a processor and a memory storing instructions which, when executed by the processor, cause the server to perform operations including: receiving document data from a user terminal, determining a format of the document data, converting the document data into normalized character information, and configuring the character information as analysis instruction information including a prompt sentence for input to both a natural language processing engine and a generative AI model; invoking the natural language processing engine to execute word segmentation, part-of-speech assignment, syntactic analysis, and semantic representation generation to produce machine-readable analysis result data, invoking the generative AI model via the prompt sentence to obtain response data, and integrating the analysis result data and the response data to extract topic information, important term information, and context information for an entirety of the document; generating, from the extracted information, search conditions and feature vectors suitable for use by a search and retrieval subsystem, and retrieving candidate resources from an information storage device based on the search conditions and the feature vectors; calculating, for each candidate resource, a relevance evaluation value indicating a degree of semantic relevance to content of the document and a usage-frequency evaluation value calculated as a temporally normalized usage index based on at least one of reference count, acquisition count, and viewing time, combining the relevance evaluation value and the usage-frequency evaluation value to obtain a recommendation evaluation value, and selecting, as recommended resources, those resources whose recommendation evaluation values satisfy a predetermined criterion; dynamically generating, for further interaction with the generative AI model, a prompt sentence including at least the topic information, the important term information, information on the recommended resources, and optionally user attribute information, transmitting the prompt sentence to the generative AI model, and receiving from the generative AI model summary information, explanation information, or additional recommendation information corresponding to the recommended resources; and associating the received information with the recommended resources, generating output data including structured recommendation results, and converting the output data into display data transmitted to the user terminal for presentation. This enables an integrated computer-implemented pipeline that (i) unifies deterministic natural language analysis and probabilistic generative AI outputs, (ii) jointly optimizes recommendation ranking using both semantic relevance and time-normalized usage-frequency metrics, and (iii) automatically constructs targeted prompt sentences from internal analysis and resource data to control the generative AI model, thereby improving the accuracy, efficiency, and contextual quality of document recommendation processing performed by the server.

The term “system” refers to an arrangement of one or more computing devices, storage devices, communication interfaces, and software components that cooperate to perform document analysis, recommendation, and information presentation processing.

The term “processor” refers to a hardware processing unit or units, such as a central processing unit or an accelerator, configured to execute instructions that implement the functions of the system.

The term “memory” refers to a hardware storage component, such as volatile memory or non-volatile memory, configured to store instructions and data used by the processor.

The term “user terminal” refers to any client-side computing device, such as a personal computer, a mobile device, or a tablet device, operated by a user to transmit document data to the server and to receive and display results.

The term “document data” refers to electronic data representing a document, including but not limited to text files, formatted files, and other machine-readable representations of written content.

The term “format of the document data” refers to a type or structure of the document data, including at least a file type, an encoding scheme, or a markup convention indicating how the document data is stored.

The term “character information” refers to a sequence of characters obtained from the document data, expressed in a machine-readable character encoding and representing the textual content of the document.

The term “normalized character information” refers to character information that has been converted into a standard character encoding and standard notation format, with at least correction or unification of character sets, line endings, and basic textual conventions.

The term “analysis instruction information” refers to structured information, including at least the normalized character information and control parameters, used to instruct a natural language processing engine or a generative AI model to perform analysis.

The term “prompt sentence” refers to one or more sequences of natural-language text included in the analysis instruction information and designed to control behavior of a generative AI model or to specify analysis tasks.

The term “natural language processing engine” refers to a software component configured to perform deterministic linguistic analysis, including at least tokenization, part-of-speech assignment, syntactic parsing, and semantic representation on text input.

The term “generative AI model” refers to a machine-learned model, such as a neural network-based language model, configured to generate text or other content in response to prompt sentences.

The term “analysis result data” refers to structured output generated by the natural language processing engine, including at least token-level, sentence-level, and document-level linguistic annotations derived from the character information.

The term “response data” refers to content, in natural-language or structured form, generated by the generative AI model in response to a given prompt sentence.

The term “topic information” refers to data representing one or more main subjects or themes of a document, derived from analysis result data and response data.

The term “important term information” refers to data representing words, phrases, or expressions identified as important or characteristic for a document, based on at least frequency or contextual significance.

The term “context information” refers to data indicating relationships among portions of a document, including but not limited to surrounding text, sentence roles, or discourse structure relevant to understanding meaning.

The term “search conditions” refers to structured parameters for retrieval, including at least query terms, filters, or constraints, used to search an information storage device for candidate resources.

The term “feature vectors” refers to numerical vectors representing characteristics of a document or terms, used for similarity computation or retrieval in a feature space.

The term “information storage device” refers to one or more storage subsystems, such as databases or index structures, configured to store and provide resources and associated metadata.

The term “candidate resources” refers to resources retrieved from the information storage device that are potential recommendations in response to a given document.

The term “relevance evaluation value” refers to a numerical or ordered indicator that quantifies a degree of semantic or topical relatedness between a candidate resource and the content of a document.

The term “usage-frequency evaluation value” refers to a numerical indicator representing a degree of usage of a resource, derived from usage logs such as accesses, acquisitions, or viewing times.

The term “usage index” refers to a usage-frequency evaluation value that has been temporally normalized or otherwise processed to account for time-based effects or other contextual factors.

The term “recommendation evaluation value” refers to a numerical value obtained by combining at least a relevance evaluation value and a usage-frequency evaluation value to indicate a suitability of a resource for recommendation.

The term “predetermined criterion” refers to at least one threshold or rule used to determine whether a recommendation evaluation value is sufficient for selection as a recommended resource.

The term “recommended resources” refers to resources selected from the candidate resources based on the recommendation evaluation values satisfying the predetermined criterion.

The term “resource information” refers to metadata or descriptive data associated with a resource, including at least titles, summaries, identifiers, or category information.

The term “user attribute information” refers to information associated with an individual user, including at least preferences, past usage patterns, or profile attributes, used to influence prompt generation or recommendation.

The term “summary information” refers to generated content that concisely describes main points or topics of a document or resource.

The term “explanation information” refers to generated content that provides interpretive or clarifying descriptions regarding a document, a resource, or a recommendation result.

The term “additional recommendation information” refers to generated content suggesting further resources, topics, or actions related to the recommended resources.

The term “output data” refers to structured data that includes recommended resources, associated summary, explanation, or additional recommendation information, and is prepared for transmission toward a user terminal.

The term “display data” refers to data derived from the output data and formatted for presentation on a user interface of the user terminal.

The term “presentation” refers to a process of causing information to be displayed or otherwise made perceivable on the user terminal for a user.

In one embodiment, a server includes at least one processor, a main memory such as a DRAM module, a non-volatile storage device such as a solid-state drive, and a network interface conforming to an Ethernet standard. The server executes an operating system such as a UNIX-compatible operating system and application software implemented, for example, in a high-level programming language. The server communicates with a terminal operated by a user through a secure network protocol such as HTTPS, and the terminal executes a web browser or a dedicated application to upload document data and display recommendation results.

The server stores in the non-volatile storage device a program that, when executed by the processor, causes the server to perform document ingestion, linguistic analysis, feature-vector generation, retrieval, ranking, and interaction with a generative AI model. The server also stores configuration data, model parameters, and index structures in the non-volatile storage device. The terminal comprises a processor, a display, an input device, and a communication module. The terminal displays user interfaces for selecting document files, submitting requests, and viewing recommended resources and generated explanations.

The server uses a text-processing stack that may include a document parsing library, such as a PDF parsing library comparable to Apache PDFBox or a general text I/O interface, to convert uploaded files into character information. The server normalizes the character information into a standard encoding such as UTF-8 and canonicalizes basic typographic conventions, including line endings and white space sequences. The server stores the normalized character sequences in a structured record, which may include fields for document identifier, character length, language label, and processing status. By consolidating heterogeneous document formats into a uniform normalized representation, the server reduces repeated parsing and thereby improves processing speed and memory locality during subsequent analysis.

The server uses a natural language processing engine comparable to spaCy or a transformer-based encoder to perform deterministic linguistic analysis. The server loads a language model into memory, where the model comprises an embedding layer, multiple attention-based layers (for example, multi-head self-attention layers), and output layers for token classification and dependency labeling. The server feeds the normalized character information into a tokenizer that segments the text into tokens and sentences based on learned or rule-based boundary criteria. The server assigns part-of-speech tags, lemmata, and dependency relations to each token. The server also computes contextual embeddings for tokens and sentences by forwarding token sequences through the stacked attention layers and retrieving intermediate hidden states. These contextual embeddings are numeric vectors, for example with a dimensionality of 256, 512, or 768, and the server stores them in a feature-vector data structure aligned with token indices and sentence indices.

The server uses the analysis result data produced by the natural language processing engine to derive topic information and important term information. The server calculates, for each token or phrase candidate, term-frequency metrics and optionally TF-IDF metrics using a numeric computation library comparable to a general machine-learning library. The server aggregates token-level statistics at the document level and ranks candidate terms based on a weighted function of frequency, positional weighting (for example, preference for terms appearing in titles or headings), and syntactic role (for example, preference for head nouns or predicate verbs). The server then applies a clustering algorithm, such as k-means or hierarchical agglomerative clustering, directly to sentence-level or document-level embeddings to detect dense regions in the feature space. Cluster centers or representative sentences from each cluster are designated as topic candidates, and the server generates topic labels, either by selecting high-importance terms within the cluster or by passing representative text to a generative AI model as part of a prompt sentence.

The server incorporates a generative AI model that in one embodiment is a transformer-based neural network comprising an embedding layer, a plurality of decoder layers, each having multi-head self-attention, cross-attention, and feedforward sublayers, and a final projection layer mapping hidden states to vocabulary logits. The server stores pre-trained weights in the non-volatile storage device and loads them into memory for inference. The generative AI model is trained, prior to deployment, by minimizing a loss function such as a cross-entropy loss over next-token prediction or instruction-following targets. During training, an optimizer such as an adaptive gradient method updates the model weights by backpropagation using gradients derived from the loss, and training data may be augmented through techniques such as random masking, sentence reordering, or paraphrasing to improve robustness. These training and architecture details ensure that the model can reliably generate coherent text when presented with a structured prompt sentence.

The server interacts with the generative AI model through explicit prompt sentences that encode analysis goals and constraints. In one example, the server generates a prompt sentence:
“You are a research assistant. Analyze the following document text and the extracted keywords. First, state the main topic in one sentence. Second, list the top 10 technical terms with brief explanations. Document text: [document excerpt]. Extracted keywords: [keyword list].”

In another example, the server generates a prompt sentence:
“Given the following document summary and keywords, suggest categories of related reference materials and questions a researcher might ask. Summary: [summary text]. Keywords: [keyword list].”

The server constructs such prompt sentences programmatically by inserting variables such as extracted keywords, topic labels, resource identifiers, and user attribute information into template strings. The server ensures that the total token count of the prompt sentence and appended context remains within the input constraints of the generative AI model by truncating or summarizing long content segments. The server then encodes the prompt sentence into tokens and supplies them to the generative AI model for inference.

The server uses a specific data structure for storing feature vectors and resource metadata. For each resource, the server maintains an entry including a resource identifier, one or more term-based features (such as TF-IDF vectors), one or more embedding-based features (such as averaged or pooled contextual embeddings), and usage-related attributes such as reference count, acquisition count, and accumulated viewing time. These fields may be stored in a relational table or in a dedicated vector index structure like a similarity-search index. The server computes a usage index for each resource by normalizing raw counts over time, for example by dividing by the number of days since registration or by applying an exponential decay function. This normalization reduces bias toward older but no longer relevant resources and provides a more technically meaningful measure of current utility.

The server determines a recommendation evaluation value for each candidate resource by applying a non-linear combination of relevance and usage metrics. In one embodiment, the server computes a relevance score using a similarity measure, such as cosine similarity, between the document's feature vector and a resource's feature vector. The server then computes a usage index based on normalized viewing and acquisition counts. The server combines these values by applying a function such as:
combined_score=α×relevance_score+β×log(1+usage_index),
where α and β are weighting parameters stored in configuration data and adjustable to tune system behavior. This algorithmic combination allows the server to systematically favor resources that are both semantically close to the input document and demonstrably useful in practice, thereby improving ranking accuracy compared to using either metric alone.

The server uses the generative AI model not only for free-form summarization but also as a controlled component integrated with the deterministic processing pipeline. For example, after computing an initial recommendation list, the server generates a prompt sentence such as:
“Given the following list of recommended resources and their brief descriptions, explain in plain language why each resource is relevant to the input document, and identify any missing categories that should also be covered. Recommended resources: [resource list]. Document summary: [summary text].”

The server supplies this prompt sentence and receives explanatory text. The server may then parse specific patterns in the explanatory text, such as phrases that indicate missing topics, and use those phrases to issue additional search queries or to adjust scores for certain resource categories. In this way, the generative AI model output is not treated as a mere human-readable narrative, but as a structured signal that the server uses to algorithmically adjust ranking and selection. This design improves the computing system's ability to refine results on the basis of semantic reasoning that would be difficult to encode using fixed rules.

The server configures the terminal interface to display recommended resources along with AI-generated summaries and explanations, but the technical improvement occurs within the server's internal data flow and computation. By standardizing document representations, caching feature vectors, and performing batch inference on the natural language processing engine and the generative AI model, the server reduces redundant computation and network traffic between modules. When deployed in a hardware environment with a graphics processing unit, the server schedules batch operations on the GPU for both embedding computation and generative inference, thereby improving throughput and reducing latency relative to naïve per-request processing on a central processing unit alone.

The server improves accuracy and reduces error by combining multiple sources of information—deterministic analysis result data, usage-frequency metrics, and generative explanations—into a unified ranking mechanism. For example, the server can detect inconsistencies between topic labels derived from deterministic clustering and topic labels produced in response to a prompt sentence. When such a discrepancy exceeds a threshold, the server can flag the case for additional analysis or adjust internal weights, thus preventing persistent misclassification of documents that share superficial keywords but differ in core subject matter. This non-conventional feedback loop between deterministic and generative components improves robustness of the system in a way that simple keyword matching cannot achieve.

The server applies rule-based and learned criteria that differ from manual human workflows. A human reader may read a document and recall a few known references based on experience, whereas the server systematically evaluates thousands or millions of resources using high-dimensional similarity metrics, time-normalized usage indices, and AI-generated semantic rationales. The server employs specific rules such as excluding resources where the cosine similarity falls below a lower threshold, boosting resources that cover under-represented topics identified in generative explanations, and dynamically adjusting prompt sentence templates based on user attribute information such as domain expertise. These rules and algorithmic steps are encoded in the program and are executed consistently and at scale, which constitutes more than a mere automation of human reading and recommendation.

In another embodiment, the server maintains separate indices for different domains or languages. The server first performs language detection on the normalized character information using a lightweight classifier. The server then selects an appropriate natural language processing model and generative AI model configuration tuned to that language. This modular design allows the server to route documents and queries to domain-and language-specific models, thereby improving both the precision of linguistic analysis and the fluency of generative outputs. Because the models and indices are optimized for particular domains, the server reduces the volume of irrelevant candidate resources and thus lowers the computational load associated with ranking and evaluation.

In yet another embodiment, the server stores historical recommendation sessions and uses them to refine generative prompt sentences. The server monitors which recommended resources are subsequently accessed or rated positively by users and logs those outcomes together with the prompt sentences and intermediate scores. The server can then analyze these logs offline, for example by training a secondary model that suggests modifications to the wording and structure of prompt sentences that tend to yield better downstream user engagement and higher relevance metrics. The server updates its prompt templates accordingly, thereby gradually improving both the quality of AI-generated explanations and the effectiveness of the recommendations. This continuous adaptation is achieved by algorithmic evaluation and reconfiguration within the computer system, rather than by manual tuning.

The terminal receives display data from the server and renders user interfaces that present recommended resources grouped by categories, with expandable sections showing summary information, explanation information, and additional recommendation information generated by the generative AI model. The user may interact with controls on the terminal to request more detailed explanations or to filter recommendations. The terminal sends these inputs back to the server, which may, for example, regenerate a prompt sentence that emphasizes particular topics or excludes specific resource types. By adjusting the internal feature-vector weighting and prompt structure in response to such inputs, the server can produce refined recommendation results without reprocessing the entire original document from scratch, thereby reducing processing time and network load.

Through these configurations and operations, the server improves computer technology in several ways. The server reduces latency and resource usage by normalizing document representations and reusing feature vectors across multiple retrieval and ranking operations. The server increases recommendation accuracy through the combined use of deterministic text analysis, feature-space similarity, time-normalized usage indices, and generative semantic signals. The server reduces error and inconsistency by systematically comparing outputs from different analysis modules and adjusting internal parameters when discrepancies occur. The server also decreases network load between components by batching requests to the generative AI model and caching AI outputs for reuse in subsequent queries involving similar topics.

By implementing these technical structures and algorithms, the system as a whole achieves processing speed improvements, ranking precision improvements, and more efficient memory and data management compared to conventional document recommendation systems that rely solely on static keyword matching or simple popularity counts. The integration of generative AI outputs into a structured, rule-based, and feature-driven pipeline constitutes a specific improvement in the functioning of the computer system, rather than an abstract idea or mere automation of human intellectual activity.

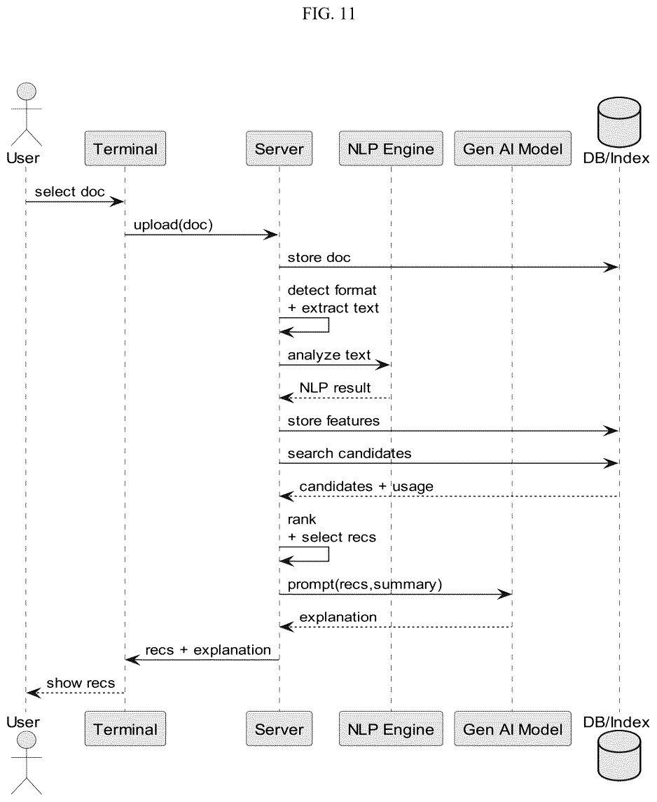

The following describes the processing flow using FIG. 11.

### Step 1

User selects a document file on the terminal.
Terminal receives a user operation specifying a file path (for example, a PDF or text file) and displays a confirmation screen.
Terminal sends an HTTP request to the server over HTTPS, with the selected file attached as multipart/form-data and with metadata such as file name, size, and content type.
Input: a document file and associated metadata selected by the user on the terminal.
Output: a network request containing the raw document file and metadata, transmitted from the terminal to the server.

### Step 2

Server receives the network request from the terminal.
Server validates the request, checks authentication or session information, and stores the raw file in a temporary storage area on a non-volatile storage device.
Server records in a database an entry including a document identifier, user identifier, file path, upload timestamp, and initial processing status.
Input: the HTTP request containing the uploaded document file and metadata.
Output: a stored raw file on disk and a document record in the database referencing the file and its initial processing state.

### Step 3

Server determines the format of the uploaded file.
Server examines the file extension and content-type header, and may read a header portion of the file to identify whether the file is a PDF, a plain text file, or another format.
Server updates the document record with a format field indicating the detected document type.
Input: the raw file bytes and metadata from the database record and storage.
Output: a format classification (for example, “PDF” or “TEXT”) associated with the document record.

### Step 4

Server converts the uploaded file into normalized character information.
Server invokes a document parsing library when the format is structured (for example, a PDF parser for PDF files) to extract textual content page by page, or uses text file I/O when the format is plain text.
Server concatenates extracted strings, converts all text to a standard character encoding such as UTF-8, replaces non-printable characters, and normalizes line endings and whitespace sequences.
Server stores the resulting normalized text in the database or in a separate text file, updating the document record with a reference to the normalized text location and marking the processing status as “normalized.”
Input: the raw file in its original format and detected format information.
Output: a continuous normalized character sequence representing the document text, along with updated document metadata referencing the normalized text.

### Step 5

Server performs basic linguistic preprocessing on the normalized text.
Server segments the normalized text into sentences based on punctuation and learned boundary rules, and divides the text into chunks (for example, by number of characters or sentences) to create units suitable for further analysis.
Server optionally detects the language of the document using a lightweight classifier and records the detected language in the document record.
Input: the normalized character sequence from Step 4.
Output: a set of text chunks, sentence boundaries, and language information stored in association with the document record.

### Step 6:

Server executes deterministic natural language processing on each text chunk.
Server selects a language-appropriate natural language processing engine and loads a language model into memory.
Server tokenizes each text chunk into tokens, assigns part-of-speech tags and lemmas, and performs syntactic parsing to identify dependencies between tokens.
Server computes contextual embeddings for tokens or sentences by forwarding token sequences through a transformer encoder or similar architecture, and stores numeric vectors aligned with token indices.
Input: the set of text chunks and language information from Step 5.
Output: analysis result data including token lists, sentence structures, linguistic annotations, and contextual embeddings for each chunk.

### Step 7

Server derives topic information, important term information, and context information from the analysis result data.
Server aggregates token-level statistics across all chunks, computing term frequencies and optionally TF-IDF values for candidate terms such as nouns, noun phrases, and verbs.
Server applies a clustering algorithm to sentence or document embeddings to group semantically similar segments and identifies cluster centers as topic candidates.
Server selects high-scoring terms within each cluster as important terms and associates representative sentences with each topic.
Input: the analysis result data from Step 6, including token annotations and embeddings.
Output: structured topic information (topic labels and representative sentences), important term information (ranked term list), and context information (links between topics and sentences).

### Step 8

Server constructs search conditions and feature vectors for retrieval.
Server generates a keyword-based query from the important term information, including required terms and optional terms, and may assign weights or priorities to each term.
Server generates a feature vector representing the document by aggregating or pooling embeddings across sentences or across topic clusters.
Server stores the search conditions and feature vector in a retrieval request structure, referencing the document identifier.
Input: topic information, important term information, and embeddings from Step 7.
Output: structured search conditions and one or more feature vectors suitable for use by a retrieval subsystem.

### Step 9

Server retrieves candidate resources from an information storage device based on the search conditions and feature vectors.
Server issues a term-based query to an index or database using the keyword-based search conditions, and may also perform a similarity search in a vector index using the feature vectors.
Server merges results from term-based and vector-based retrieval into a unified set of candidate resources, each associated with a resource identifier, content metadata, and preliminary similarity scores.
Input: the search conditions and feature vectors from Step 8.
Output: a list of candidate resources with associated identifiers, metadata, and initial relevance indicators.

### Step 10

Server retrieves usage data for each candidate resource and computes usage-frequency evaluation values.
Server queries a usage log or statistics table for each candidate resource to obtain metrics such as reference counts, acquisition counts, and accumulated viewing times over one or more time windows.
Server applies a normalization function to these raw metrics, for example dividing counts by elapsed time or applying exponential decay, to compute a usage index that emphasizes recent and sustained usage.
Input: the list of candidate resource identifiers from Step 9 and usage logs stored in the system.
Output: a usage-frequency evaluation value or usage index for each candidate resource.

### Step 11

Server calculates recommendation evaluation values by combining relevance and usage metrics.
Server computes a content relevance score for each candidate resource, for example using cosine similarity between the document feature vector and the resource feature vector, and may integrate text-based similarity scores from search results.
Server combines the relevance score with the usage index by applying a predetermined formula, such as a weighted sum with logarithmic scaling of the usage index.
Server assigns a recommendation evaluation value to each resource and stores these values in a ranking structure.
Input: relevance indicators from Step 9 and usage indices from Step 10.
Output: a recommendation evaluation value for each candidate resource and a ranked list structure.

### Step 12

Server selects recommended resources based on the recommendation evaluation values.
Server sorts candidate resources in descending order of recommendation evaluation value and filters out any resources whose values fall below a predetermined threshold.
Server limits the number of resources to a configured maximum and produces a final list of recommended resources, each with a recommendation score and summary metadata.
Input: the recommendation evaluation values from Step 11.
Output: a pruned and ordered list of recommended resources designated as the recommendation result for the document.

### Step 13

Server generates a prompt sentence for a generative AI model using internal analysis data and recommended resources.
Server selects topic information, important term information, a document summary, and information about recommended resources, such as titles or short descriptions.
Server inserts these elements into a template string to form a natural-language prompt sentence that specifies analysis tasks for the generative AI model, for example asking for an explanation of why each resource is relevant.
Server ensures that the overall prompt length stays within the model's input limit by truncating or summarizing text when necessary.
Input: topic information, important term information, document summary, and recommended resource information from Steps 7 and 12.
Output: a prompt sentence or a set of prompt sentences ready to be supplied to the generative AI model.

### Step 14

Server invokes the generative AI model with the prompt sentence.
Server encodes the prompt sentence into tokens using the model's tokenizer and sends the token sequence, together with generation parameters such as maximum length and temperature, to the generative AI model for inference.
Server receives from the generative AI model a generated response, which may include summary information, explanation information, or additional recommendation suggestions.
Input: the prompt sentence from Step 13 and model configuration parameters.
Output: response data generated by the generative AI model, represented as a text sequence or structured text.

### Step 15

Server integrates the generative AI model's response with the recommended resources.
Server associates segments of the response data with corresponding recommended resources, for example mapping explanations to individual resource identifiers based on the order or explicit tags in the response.
Server refines the recommendation result by appending AI-generated summaries and explanations to each resource entry and may adjust ranking for certain categories in light of additional semantic cues from the response.
Input: the recommended resource list from Step 12 and the response data from Step 14.
Output: enriched recommendation output data that includes recommended resources and associated AI-generated information.

### Step 16

Server generates display data for the terminal.
Server converts the enriched recommendation output data into a format suitable for presentation, such as a structured response that includes titles, scores, topic labels, summaries, explanations, and links for each recommended resource.
Server serializes this structure as a response payload and transmits it to the terminal via an HTTP response over HTTPS.
Input: the enriched recommendation output data from Step 15.
Output: a response payload containing display data for rendering the recommendation result on the terminal.

### Step 17

Terminal receives the display data from the server.
Terminal parses the response payload and constructs user interface components such as lists, expandable panels, and text fields to display recommended resources and AI-generated explanations.
Terminal renders the interface on the display, allowing the user to review, scroll, and select recommended resources, and to issue further commands such as requesting more detailed explanations or filtering results.
Input: the display data transmitted from the server in Step 16.
Output: a visual presentation of recommended resources and associated information on the terminal display, and any subsequent user interactions that may trigger new processing cycles.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional document recommendation and citation-support systems primarily rely on static keyword matching, simple citation counts, or manually tuned ranking rules executed by general-purpose computing hardware. Such systems typically process academic documents and user queries independently, without tightly integrating multi-stage natural language processing, generative artificial intelligence models, and user-interaction driven feedback loops into a unified computational pipeline. As a result, these systems often produce context-insensitive recommendations that do not adequately reflect the semantic structure of documents, the evolving interests of individual users, or the actual usage patterns observed at the terminal apparatus.

In existing architectures, a processor generally executes natural language analysis and recommendation logic as separate, loosely coupled modules, and does not exploit the capability of generative artificial intelligence models to refine intermediate representations and prompts based on prior system outputs and user behavior. The processor typically applies fixed scoring functions that are not dynamically re-weighted according to a learned model of the user's interests. This leads to inefficiencies at the computing level, such as repeated analysis of low-relevance documents, poor utilization of generative models, and increased processing overhead caused by the absence of adaptive control over prompt sentences and evaluation functions.

Furthermore, conventional systems do not maintain a structured, machine-consumable representation of analysis result data, generation result data, citation information, and user interest information in a manner that allows the processor to compute, update, and reuse document relevance indices across multiple sessions. The lack of such a structured representation means that the processor cannot effectively coordinate natural language processing mechanisms, generative artificial intelligence models, and terminal-side interaction data to improve the ranking and selection of contextually citable references. Consequently, the underlying computer system does not efficiently transform raw document data and user interaction logs into a refined, high-utility recommendation state, thereby limiting both performance and personalization at the system level.

Accordingly, there is a need for a computer-implemented technique in which a processor orchestrates the acquisition of document data, the natural language analysis of text data, the generative modeling of summaries and relevance explanations, and the dynamic updating of user interest information and evaluation functions, in an integrated manner. Such a technique should improve the functioning of the computer system itself by enabling more efficient document filtering and ranking, reducing unnecessary calls to remote models, and generating higher-quality, context-aware reference information that is better aligned with user behavior and preferences.

The specific processing by the specific processing unit 290 of the data processing device 12 in Application Example 1 is realized by the following means.

The present invention provides a server comprising a processor configured to receive, from a terminal apparatus, user interest information and a topic input by a user; to acquire, on the basis of a prompt sentence including the topic, document data related to the topic from an external information providing apparatus and an internal information storage apparatus; to extract text data from the acquired document data and input the text data into an analysis information processing mechanism having a natural language processing function so as to generate, for each piece of the document data, analysis result data including subject information and keyword information and to store the analysis result data; to generate a prompt sentence that supplies structured data including the topic and the analysis result data to a generative artificial intelligence model, and to input the prompt sentence and the structured data into the generative artificial intelligence model so as to obtain generation result data including summary information and relevance-reason information for each piece of the document data; to apply an evaluation function to the analysis result data, the generation result data, citation frequency information, publication time information, and the user interest information to calculate a relevance index for each piece of the document data, and to select, as contextually citable reference information, document data for which the relevance index is equal to or greater than a predetermined value; to acquire viewing operation information and selection operation information performed by the user with respect to the reference information presented on the terminal apparatus, to update the user interest information on the basis of the operation information, and to dynamically change, in accordance with the updated user interest information, the prompt sentence to be input to the generative artificial intelligence model in subsequent processing and weighting of the evaluation function; and to cause a display apparatus of the terminal apparatus to present the selected reference information and the generation result data to the user. This enables the computer system to internally transform raw document data and user interaction data into structured analysis and generation results, to iteratively refine prompts and scoring logic based on learned user interests, and to thereby improve the efficiency and accuracy of context-aware reference selection and recommendation processing executed by the processor.

The term “processor” refers to a hardware or virtual information processing unit, such as a central processing unit or a computing core, that executes program instructions to perform data acquisition, analysis, generation, evaluation, and control operations described in the present disclosure.

The term “terminal apparatus” refers to an information processing device operated by a user, such as a mobile communication device, a head-mounted display device, or a general-purpose computing device, that transmits user input to a server and presents information received from the server to the user.

The term “user interest information” refers to data representing preferences, interests, or behavioral tendencies of a user, including at least one of explicitly provided interest categories, topics, or keywords, and implicitly derived information based on viewing history, selection operations, and interaction logs.

The term “topic” refers to a subject, theme, or field of interest specified by a user, expressed as a natural language phrase, keyword, or combination of keywords, which serves as a basis for acquiring and filtering document data.

The term “prompt sentence” refers to text data, expressed in a natural language or a structured instruction format, that is input to an analysis information processing mechanism or a generative artificial intelligence model to control or guide the content, style, or scope of processing to be performed.

The term “document data” refers to digital data representing content such as academic documents, technical descriptions, articles, or similar information resources, including at least metadata and associated text data that can be analyzed by natural language processing.

The term “external information providing apparatus” refers to an information processing system or service, accessible via a communication network, that stores and supplies document data or related metadata to the server.

The term “internal information storage apparatus” refers to a storage device or subsystem, such as a database system or a file storage system, managed by the server and configured to store document data, analysis result data, generation result data, and user-related information.

The term “text data” refers to character-based information extracted from document data, including at least a title, abstract, body text, or other textual portions suitable for processing by natural language processing functions.

The term “analysis information processing mechanism” refers to a hardware and/or software component, including at least a natural language processing engine, configured to receive text data and output structured analysis result data such as subject information and keyword information.

The term “natural language processing function” refers to a computational capability that analyzes text expressed in a human language to extract structural and semantic information, including but not limited to subject classification, keyword extraction, entity recognition, and contextual relationship detection.

The term “analysis result data” refers to structured data obtained by processing text data with the analysis information processing mechanism, the structured data including at least subject information and keyword information associated with corresponding document data.

The term “subject information” refers to data representing main themes, topics, or categories to which a piece of document data belongs, determined by natural language processing or classification algorithms.

The term “keyword information” refers to data representing salient terms, phrases, or concepts extracted from document data, which are considered important for characterizing the content or for determining relevance to a topic.

The term “generative artificial intelligence model” refers to a machine-learned model, such as a neural network-based language model, configured to generate text or structured output in response to input data, including prompt sentences and structured context, and to output generation result data such as summaries or explanations.

The term “structured data” refers to data organized in a predefined schema or format, such as a list, table, or hierarchical representation, that includes at least topic information, analysis result data, and optionally metadata such as citation frequency information and publication time information.

The term “generation result data” refers to data output by the generative artificial intelligence model in response to a prompt sentence and structured data, the data including at least summary information and relevance-reason information for each piece of document data.

The term “summary information” refers to concise text that describes main points or key content of a piece of document data, generated or refined by the generative artificial intelligence model.

The term “relevance-reason information” refers to explanation text indicating why a piece of document data is considered relevant to a topic, a user interest, or another reference context, generated or refined by the generative artificial intelligence model.

The term “citation frequency information” refers to data indicating how many times a piece of document data has been cited or referenced in other documents, or a related metric representing citation impact.

The term “publication time information” refers to data indicating a time attribute of document data, such as publication date, release date, or registration date, used for evaluating recency or temporal relevance.

The term “evaluation function” refers to a computational function or algorithm that receives, as input, one or more of analysis result data, generation result data, citation frequency information, publication time information, and user interest information, and outputs a numerical or categorical relevance index for each piece of document data.

The term “relevance index” refers to a value or score computed by the evaluation function that represents a degree of relevance or suitability of document data with respect to a topic, a user interest, or a citation context.

The term “contextually citable reference information” refers to document data or associated metadata selected on the basis of the relevance index, which is determined to be appropriate for citation in view of a specific topic, context, or user need.

The term “viewing operation information” refers to data indicating operations performed by a user to view or browse reference information on a terminal apparatus, including at least display events, scroll events, or opening of detail views.

The term “selection operation information” refers to data indicating operations performed by a user to explicitly select, bookmark, approve, dismiss, or otherwise interact with reference information presented on a terminal apparatus.

The term “interest vector” refers to a data structure, such as a numerical vector or similar representation, that encodes a user's interest distribution across multiple topics, keywords, or categories on the basis of viewing history information and preference information.

The term “preference information” refers to data representing explicit or inferred user preferences, including positive or negative feedback regarding specific topics, documents, or recommendations.

The term “viewing history information” refers to data representing a history of user interactions with displayed content, including which reference information or document data has been accessed, for how long, and in what sequence.

The term “display apparatus” refers to a hardware component of a terminal apparatus, such as a display panel or a head-mounted display element, configured to visually present information to a user under control of the processor.

The term “ranking information” refers to data indicating an order or relative priority assigned to multiple pieces of document data, typically based on relevance indices or other evaluation metrics.

The term “explanation text information” refers to text generated or refined by the generative artificial intelligence model that explains the basis, rationale, or criteria for ranking or selecting particular document data.

The term “server” refers to an information processing system, including at least one processor and at least one memory, configured to perform the acquisition, analysis, generation, evaluation, updating, and presentation control operations described in the present disclosure in cooperation with one or more terminal apparatuses.

In one embodiment, a server cooperates with one or more terminal apparatuses operated by a user to implement the claimed system. The server includes at least one processor, a main memory, a non-volatile storage apparatus, and a network interface. The terminal includes at least one processor, a display apparatus, an input unit such as a touch panel or microphone, a local memory, and a wireless or wired communication unit. The user operates the terminal to input a topic, to view recommended reference information, and to provide feedback. The server executes a program that realizes the functions described below.

The server uses general-purpose computing hardware, for example an x86_64 or ARM-based multi-core processor, system memory such as DDR-type random access memory, and a storage apparatus such as a solid-state drive. The server executes an operating system, for example a Unix-like operating system, and an application framework, for example a web server process and an application server process. The server uses a database management system, for example a relational database management system, to store document data, analysis result data, generation result data, and user interest information as structured records.

The server uses a natural language processing engine as the analysis information processing mechanism. In one example embodiment, the server uses a cloud-based natural language processing software service comparable to a commercial cloud natural language API. The server calls this engine through an application programming interface to obtain subject information and keyword information for each piece of document data. The server also uses a generative AI model comparable to a large-scale transformer-based language model. The generative AI model includes a multi-layer neural network, in which each layer performs self-attention operations and feed-forward transformations over token embeddings of an input sequence that includes a prompt sentence and structured data. The generative AI model has been trained in advance on large text corpora using a loss function such as cross-entropy between predicted token distributions and ground-truth tokens, and the model parameters are optimized by an algorithm such as stochastic gradient descent or Adam. The server accesses this generative AI model through a network-based application programming interface.

The server stores document data in a structured form. For each document, the server stores a record containing at least a document identifier, title text, abstract text, full text or a link to full text, citation frequency information, publication time information, and additional metadata. The server also stores analysis result data for each document. The analysis result data includes subject information represented, for example, as category labels or topic vectors, and keyword information represented as a list of terms with associated importance scores. The server further stores generation result data for each document, including summary information and relevance-reason information produced by the generative AI model. The server associates the generation result data with the corresponding document identifier and user identifier.

The server maintains user interest information as a data structure that includes explicit interest topics provided by the user and implicit interest profiles derived from past interactions. In one embodiment, the server represents the user interest information as an interest vector, which is a numerical vector in a latent topic space. The server updates this interest vector by aggregating viewing history information and preference information. The server calculates the interest vector, for example, by applying a weighted average of topic vectors associated with documents that the user has selected or viewed for a threshold duration. The server stores the interest vector in the database as part of the user profile.

The server uses a specific data structure to represent structured data supplied to the generative AI model. In one embodiment, the server forms, for each request, a list of candidate documents, and for each candidate document, the server collects title text, abstract text, keyword information, citation frequency information, publication time information, and optionally a similarity score derived from a text embedding. The server then serializes this structured data into a text representation that is embedded in the prompt sentence, for example by using a consistent label format such as “Title: . . . ; Abstract: . . . ; Keywords: . . . ; Citations: . . . ; Year: . . . ”. This structured representation allows the generative AI model to parse and reason about document attributes in a machine-oriented way, beyond simple natural language text.

The server uses a defined evaluation function to compute a relevance index for each document. In one embodiment, the server calculates the relevance index as a weighted sum of multiple feature values. The features include a similarity score between the user's topic and the document's subject information, a similarity score between the user interest vector and a document-specific topic vector, a normalized value of citation frequency information, a recency score derived from publication time information, and a score derived from the relevance-reason information generated by the generative AI model. The server stores weighting parameters for these features, and the server adjusts these parameters over time according to observed user behavior. By computing the relevance index using numeric operations over structured feature vectors, the server improves the precision of document ranking compared to systems that rely solely on keyword counting or simple rule-based logic.

The server uses the generative AI model not only to output human-readable summaries but also to refine internal signals. The server constructs the prompt sentence so that the generative AI model is requested to identify which of the listed documents are most relevant to the user's interests, to provide “relevance-reason information,” and to propose a ranking. For example, the server can generate a prompt sentence such as:
“You are assisting a researcher interested in: ‘AI technology’. Below is a list of academic papers with title, abstract, keywords, citation count, and year. From these, select the 10 most relevant and contextually citable references. For each selected paper, output: (1) title, (2) a 2-3 sentence summary, (3) main topics as keywords, and (4) a 1-2 sentence explanation of why this paper is relevant to the user's interest in AI technology.”

In another example, the server can generate a prompt sentence such as:
“The user has previously shown strong interest in deep learning and generative AI models. Given the following candidate papers on AI technology, rank them by relevance and provide concise summaries. Focus on papers related to deep learning, transformers, and generative AI models, and de-emphasize purely theoretical reinforcement learning papers unless they are widely cited.”

In another example, the server can generate a prompt sentence such as:
“The user's prompt sentence is: ‘Please analyze the latest papers on AI technology and recommend the top 10 papers that match my interests.’ Using the provided paper metadata (title, abstract, keywords, citation count, year), create a recommendation list and explain in up to 3 sentences per paper why each paper is a good match for the user.”

By embedding structured document attributes, the topic, and the user interest vector into these prompt sentences, the server enables the generative AI model to perform multi-criteria reasoning that is difficult to reproduce with manual rules.

The server uses a specific algorithm to update the user interest vector and adjust the evaluation function. When the user views or selects reference information on the terminal, the server records viewing history information that includes, for each document, time-stamped events such as “list viewed,” “details opened,” “bookmark added,” or “dismissal action.” The server assigns numerical weights to different types of events, for example a higher weight to a bookmark action than to a brief listing view. The server computes, for each topic dimension, an incremental update quantity derived from the topic vector of the interacted document multiplied by an event-specific weight. The server adds this quantity to the user interest vector, and optionally normalizes the resulting vector. The server then changes the weighting parameters of the evaluation function by moving them in the direction that increases the relevance index of documents that received positive interactions and decreases the relevance index of documents that were ignored or dismissed. The server can use a gradient-based method or a reinforcement-learning-style update rule to adjust these weights. This algorithmic update is a technical process that changes the internal computational state of the system to produce more accurate relevance indices in future operations.

The server integrates the natural language processing engine, the generative AI model, and the evaluation function in a pipeline that is optimized for computational efficiency. For example, the server caches analysis result data for documents that have already been processed, so that the same documents are not re-analyzed by the natural language processing engine for each user. The server also caches generation result data for frequently requested combinations of topic and document list, reducing the number of calls to the generative AI model. The server uses a batch-processing strategy to group multiple documents and multiple user requests into a single call to the generative AI model when possible. This reduces communication overhead between the server and the external generative AI model service and lowers latency for the user.

The server uses a specific internal data flow to realize these efficiencies. When new document data is acquired from an external information providing apparatus, the server stores the data in the internal storage apparatus and triggers a background analysis task that calls the natural language processing engine. When a user later requests recommendations for a particular topic, the server retrieves pre-computed analysis result data and only invokes the generative AI model to generate summaries and relevance-reason information for the subset of documents that pass an initial filter. The initial filter can be calculated by a lightweight operation such as computing cosine similarity between a pre-computed embedding of the user's topic and document embeddings stored in the database. By structuring the system in this way, the server reduces the number of expensive natural language processing and generative model calls, thereby improving processing speed and reducing computational cost.

The server uses the generative AI model in a way that is not a mere automation of a human mental process. The server provides to the generative AI model a large set of structured features, including numeric citation scores, interest vector components, and topic embeddings, and the model processes these features together with natural language text. The generative AI model, implemented as a multi-layer transformer network, applies matrix multiplications and non-linear activation functions to high-dimensional vectors of token embeddings. Attention heads within each layer compute attention weights based on similarity of query and key vectors, thereby redistributing representation among tokens. These operations are executed at hardware level using vectorized instructions and, in some implementations, specialized accelerators such as graphics processing units or tensor processing units. The server leverages these low-level computational characteristics to process large volumes of documents at speeds and scales unattainable by human analysis.

The server improves the underlying computer technology in several ways. First, by maintaining and updating the user interest vector and document relevance indices as structured numeric data within the database, the server enables rapid retrieval of candidate documents through indexed queries and vector similarity search (for example using approximate nearest neighbor algorithms). This reduces the time to identify promising candidates for generative processing. Second, by integrating generative AI output into the evaluation function as an explicit feature, the server converts opaque natural language explanations into machine-usable signals, improving ranking accuracy and making better use of computational resources. Third, by dynamically adjusting the prompt sentence and evaluation function weights based on user behavior, the server minimizes redundant processing and steers computational effort toward document regions and topic dimensions most likely to yield useful results. As a result, the server achieves higher throughput, lower average latency, and improved recommendation precision compared to systems that use fixed prompts and static ranking functions.

The terminal implements a user interface tailored to present the generated reference information efficiently and to capture operation information accurately. The terminal displays, for each recommended document, the title, summary information, keywords, citation frequency information, and publication time information in distinct graphical regions. The terminal provides user interface controls for bookmarking, dismissing, and requesting more details. The terminal sends minimal, structured events to the server, such as “document_id=X, action=BOOKMARK, timestamp=T,” instead of transmitting entire screen contents. This structure reduces communication bandwidth and simplifies server-side parsing, which contributes to lower communication load and faster server response.

The user operates the terminal in various contexts. For example, the user can input an initial topic such as “AI technology” into the terminal using a keyboard or voice input. The user can issue a prompt sentence such as “Please analyze the latest papers on AI technology and recommend the top 10 papers that match my interests, including extracted keywords and short summaries.” The terminal transmits this prompt sentence and associated topic information to the server. Later, after receiving recommendations, the user can refine the interest, for example by instructing “Focus on generative AI models and deep learning, and exclude robotics applications.” The server then updates the structured data and prompt sentences accordingly.

In one variation, the server computes document embeddings using an embedding model that can be a smaller neural network separate from the generative AI model. This embedding model maps textual content and keywords into a fixed-dimensional vector space where cosine similarity approximates semantic similarity. The server stores these embeddings in the database and uses them as features in the evaluation function. The embedding model is trained offline using a contrastive learning objective that pulls semantically similar documents closer together in the vector space and pushes dissimilar documents apart. By using such embeddings, the server can perform rapid approximate nearest neighbor searches using specialized indexing structures, thereby improving candidate selection speed before invoking heavier generative processing.

In another variation, the server modifies the architecture and training regime of the generative AI model to incorporate citation frequency information and publication time information directly into the token sequence. For example, the server encodes citation counts and years as special tokens and trains the model to consider these tokens when generating relevance-reason information. This configuration allows the generative AI model to learn non-trivial interactions between textual content and quantitative metrics, which would be extremely burdensome to specify manually as explicit rules.

In still another variation, the server deploys multiple generative AI models with different parameter sizes or specializations. The server uses a smaller model to perform coarse-grained filtering and summary generation and uses a larger model only for documents that pass a first relevance threshold. The server selects which model to call based on computational budget, network conditions, or user-latency constraints. This hierarchical model usage further reduces processing time and network load while maintaining high quality for the most promising references.

In summary, the server, the terminal, and the user cooperate through a concrete technical architecture, specialized data structures, and defined algorithms to transform raw document data and user interaction information into highly structured analysis result data and generation result data. The server then uses these data to compute refined relevance indices and contextually appropriate reference information, while continuously adapting prompts and scoring logic to the evolving user interest vector. This configuration yields technical improvements in processing speed, ranking accuracy, data management, and communication efficiency, and therefore constitutes more than a mere automation of human mental processes or business logic.

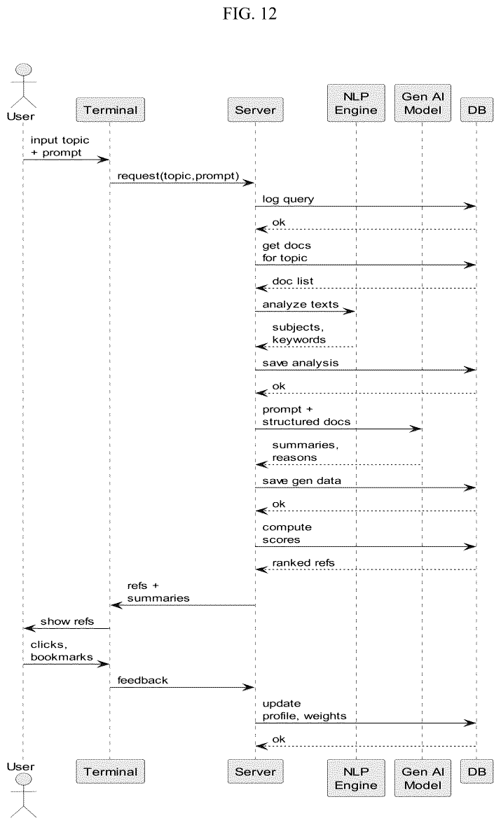

The following describes the processing flow using FIG. 12.

### Step 1

The user inputs a topic and an optional prompt sentence on the terminal.
The terminal receives, as input, raw interaction data including keystrokes, touch events, or speech signals. The terminal uses an input module (keyboard handler, touch handler, or speech recognizer) to convert these signals into text data representing at least a topic (for example, “AI technology”) and optionally a user-defined prompt sentence (for example, “Please analyze the latest papers on AI technology and recommend the top 10 papers that match my interests.”). The terminal then constructs a request object containing the user identifier, the topic text, the prompt sentence, device information, and a timestamp. As output, the terminal produces a structured request payload (for example, JSON) and transmits this payload to the server over a network using an HTTP client.

### Step 2

The server receives the request payload and registers the query.
The server receives, as input, the structured request payload sent from the terminal via a network interface. The server parses the payload using a request handler to extract fields such as user identifier, topic text, and prompt sentence. The server generates a unique query identifier (for example, by applying a random or sequential identifier algorithm) and creates a new record in a query log table. The server stores the extracted fields along with the query identifier and timestamp in a database. As output, the server produces a stored query record and an internal context object that bundles the user identifier, topic, prompt sentence, and query identifier for subsequent processing.

### Step 3

The server retrieves candidate document data related to the topic.
The server receives, as input, the internal context object including the topic and query identifier. The server formulates one or more search queries using the topic text and possibly synonyms or related terms derived from a thesaurus or embedding lookup. The server sends these search queries to an external information providing apparatus (for example, a bibliographic database service) and to an internal information storage apparatus (for example, a relational database or search index). The server receives lists of document metadata as responses, including titles, abstracts, identifiers, citation counts, and publication times. The server merges and deduplicates these lists based on document identifiers. As output, the server produces a consolidated candidate document list associated with the query identifier and stores it in the database.

### Step 4

The server fetches and normalizes text data from the candidate documents.
The server receives, as input, the consolidated candidate document list containing document identifiers and access locations (for example, URLs or file paths). The server retrieves full text or partial text for each document by issuing HTTP GET requests to external servers or by reading from local storage. The server then applies a text extraction module (for example, a PDF-to-text converter or HTML parser) to convert binary file formats into plain text. The server performs normalization operations such as removing markup, normalizing whitespace, converting character encodings, and optionally stripping boilerplate sections. As output, the server generates normalized text data for each candidate document and stores these text strings in the internal information storage apparatus linked to the corresponding document identifiers and query identifier.

### Step 5

The server analyzes the normalized text data using a natural language processing engine.
The server receives, as input, the normalized text data for each document and the corresponding document identifiers. The server batches text data into requests to an analysis information processing mechanism that provides a natural language processing function. The server submits the text as input to this mechanism via an application programming interface and requests operations such as topic classification, keyword extraction, and entity recognition. The analysis engine applies internal algorithms, such as tokenization, part-of-speech tagging, and statistical or neural classification models, to compute subject labels and keyword lists with relevance scores. As output, the server obtains analysis result data for each document, including subject information and keyword information, and stores this analysis result data in the database associated with the document identifiers and query identifier.

### Step 6

The server computes feature vectors and preliminary similarity scores.
The server receives, as input, the analysis result data for each document, the topic text, and optionally pre-computed document embeddings. The server encodes the topic text into a numeric vector representation using an embedding model or a term-vector representation. The server then computes, for each document, one or more similarity scores, such as cosine similarity between the topic vector and a document topic vector derived from subject information and keyword information. The server may also normalize citation counts and convert publication time information into recency scores. As output, the server produces a feature vector for each document, combining similarity scores, normalized citation values, and recency scores, and stores these feature vectors as part of the document metadata.

### Step 7

The server constructs structured data and a prompt sentence for the generative AI model.
The server receives, as input, the candidate document metadata, the analysis result data, the feature vectors, and the user interest information. The server selects an initial subset of documents (for example, the top N by preliminary similarity) to include in the generative processing. The server then creates structured data for each selected document, including at least title, abstract, keyword information, citation frequency information, and publication time information. The server formats this information into a textual structure with labels, such as “Title: . . . ; Abstract: . . . ; Keywords: . . . ; Citations: . . . ; Year: . . . ”. The server generates a prompt sentence that embeds the user's topic, optionally a summary of the user interest vector, and a description of the required output, for example: “From the following list of papers related to ‘AI technology’, select the most relevant and generate summaries and reasons for relevance.” As output, the server produces a complete input text for the generative AI model, consisting of the prompt sentence followed by the structured document descriptions.

### Step 8

The server calls the generative AI model and obtains generation result data.
The server receives, as input, the composed input text that includes the prompt sentence and structured document data. The server sends this text to a generative AI model endpoint via a network protocol, specifying parameters such as maximum output length and output style constraints. The generative AI model, implemented as a transformer-based neural network, processes the input sequence by applying attention layers, linear transformations, and non-linear activations to produce a probability distribution over output tokens at each position, and generates text that contains summary information, relevance-reason information, and optionally ranking information. The server receives the generated text as output from the model. The server parses this text to extract structured generation result data for each document, including at least a summary and a relevance explanation. As output, the server stores the generation result data in the database associated with the corresponding document identifiers, user identifier, and query identifier.

### Step 9

The server calculates a refined relevance index for each document.
The server receives, as input, the feature vectors for each document, the analysis result data, the generation result data, the user interest information, citation frequency information, and publication time information. The server applies an evaluation function that combines these inputs, for example by computing a weighted sum or another numeric aggregation over feature values derived from similarity scores, interest-vector alignment, normalized citation counts, recency scores, and signals derived from the relevance-reason information (such as presence of certain key phrases or model-provided relevance scores). The server may also apply a non-linear transformation or normalization (for example, logistic scaling) to convert raw scores into a bounded relevance index. As output, the server computes and stores a relevance index value for each document in the database.

### Step 10

The server selects contextually citable reference information based on the relevance index.
The server receives, as input, the relevance index for each document within the candidate set and selection parameters such as a threshold value or a maximum number of recommendations. The server filters the document list by selecting documents whose relevance index is greater than or equal to the threshold, and if necessary, truncates the list to a fixed number by ordering the documents in descending order of relevance index. The server then compiles, for each selected document, a reference entry that includes title, authors if available, citation information, publication time information, summary information, and relevance-reason information. As output, the server produces a set of selected reference entries to be delivered to the terminal as contextually citable reference information.

### Step 11

The server generates a response payload and transmits it to the terminal.
The server receives, as input, the selected reference entries, the query identifier, and user identifier. The server constructs a response payload that includes a list of references with their metadata, summaries, relevance explanations, and any ranking information, along with general information such as the topic and timestamp. The server serializes this payload into a structured format such as JSON. The server sends the serialized payload to the terminal via a network interface using an HTTP response. As output, the server produces a network message that carries the recommendation and reference information to the terminal.

### Step 12

The terminal displays the selected reference information and captures user operations.
The terminal receives, as input, the response payload from the server via its communication unit. The terminal parses the JSON or other structured format to recover the list of reference entries. The terminal maps the data fields to user interface components, such as list items, text labels, and control buttons. The terminal renders the list on the display apparatus, showing for each entry the title, summary, keywords, citation data, and publication time. The terminal also attaches event handlers to user interface controls that allow the user to scroll, open details, bookmark, or dismiss items. As output, the terminal presents the reference information visually to the user and generates structured event data (for example, “document_id=X, action=OPEN_DETAIL”) when the user interacts with the interface.

### Step 13

The user reviews the recommendations and provides implicit and explicit feedback.
The user receives, as input, the rendered list of reference entries displayed on the terminal. The user reads the titles and summaries, opens details for certain references, bookmarks items considered useful, and possibly dismisses items that appear irrelevant. The user may also provide explicit feedback using interface controls such as “thumbs up” or “thumbs down” buttons. Through these physical interactions, the user creates observable behavior that the terminal encodes as interaction events. As output, the user causes the terminal to log such events and, in some configurations, to immediately send selected events to the server as feedback.

### Step 14

The terminal sends interaction logs to the server.
The terminal receives, as input, raw interaction events generated by user operations, including identifiers of the affected reference entries, action types, and timestamps. The terminal aggregates these events for a defined interval or transmits them immediately, depending on configuration. The terminal then constructs a feedback payload containing user identifier, query identifier, document identifiers, action types, and time data. The terminal sends this payload to the server via the network interface. As output, the terminal produces a structured feedback message that encodes the user's implicit and explicit preferences.

### Step 15

The server updates user interest information and evaluation function parameters.
The server receives, as input, the feedback payload containing interaction events. The server maps each event to the corresponding document and retrieves the document's topic vector or subject information from the database. The server assigns numerical weights to event types (for example, a higher weight for bookmarking than for a brief view) and computes an update vector by multiplying document topic vectors by event weights and summing the results. The server then updates the user interest vector by adding the update vector and optionally normalizing the result. The server also adjusts the parameters of the evaluation function by comparing the current relevance indices with the observed user preferences and slightly increasing or decreasing feature weights to better align future indices with user behavior. As output, the server produces an updated user interest vector and updated evaluation function parameters stored in the database.

### Step 16

The server modifies future prompt sentences and selection logic based on the updated profile.
The server receives, as input, the updated user interest vector and the adjusted evaluation function parameters. For subsequent queries from the same user, the server embeds a summary of the user interest vector into the prompt sentence to the generative AI model, for example by including instructions such as “The user has shown strong interest in deep learning and generative AI models.” The server also changes selection logic for candidate documents by giving higher initial scores to documents whose topic vectors align more closely with the user interest vector. As output, the server produces modified prompt sentences and altered scoring behavior that will be applied in the next processing cycle, thereby improving personalization and computational efficiency for future recommendations.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information retrieval systems that operate in response to user queries typically rely on keyword-based matching or simple statistical ranking. Such systems are often implemented as generic search engines or database front-ends that treat user input as a flat string of terms and match those terms against pre-indexed documents. As a result, these systems are limited in their ability to understand the contextual meaning of a user's query, to distinguish between different conceptual aspects within the same query, and to select information sources that are genuinely citable in the specific context intended by the user.

In addition, existing systems usually do not leverage advanced generative AI models in a systematic and integrated manner for both semantic analysis of a prompt sentence and subsequent refinement of retrieved information sources. Even when a generative AI model is used, it is often employed merely to generate natural language answers, without producing structured analysis results that can be used to drive downstream retrieval, ranking, and selection processes. This can lead to the retrieval of information sources that are superficially related in terms of keywords but are not contextually suitable as citations or references for the user's actual information need.

Furthermore, known systems that incorporate vector-based similarity search or embedding techniques typically apply such techniques in isolation, without combining them with prompt-aware semantic analysis performed by a generative AI model. Consequently, these systems cannot fully exploit the rich semantic representation of the user's prompt sentence and the retrieved candidate information sources. This limitation can result in suboptimal ranking, inclusion of off-topic or low-quality sources, and increased manual effort by the user to identify appropriate references.

From a computer technology perspective, there is also a need to improve the way in which server-side components coordinate analysis by a generative AI model with downstream data processing. Existing architectures often treat the AI model as a black-box text generator, rather than as a component in a structured processing pipeline that transforms an input prompt sentence into machine-usable analysis result data, search queries, vector representations, and filtered result sets. This lack of tight integration prevents efficient use of computational resources and hinders the scalability and reliability of systems that must process large volumes of queries and information sources.

Accordingly, there is a need for an improved computer-implemented technique in which a server obtains a prompt sentence from a user terminal, uses a generative AI model to perform structured semantic analysis of the prompt sentence, generates search queries for an information source storage based on the analysis result, evaluates contextual relevance of retrieved information source candidates using embedding-based similarity, and formats only contextually citable information sources into response data that can be readily consumed by the user terminal. Such an improvement would enhance the technical functioning of the server-side information retrieval pipeline, reduce unnecessary data transfer and processing of irrelevant sources, and provide higher-quality, context-appropriate information sources to the user.

The specific processing by the specific processing unit 290 of the data processing device 12 in Example 2 is realized by the following means.

The present invention provides a server comprising a processor configured to receive a prompt sentence from a user terminal, to input the prompt sentence to a generative AI model as an instruction to perform analysis using natural language processing so as to obtain analysis result data including keywords and concepts, to generate search query data for searching an information source storage based on the analysis result data, to search the information source storage by using the search query data and extract a plurality of information source candidate data items, to convert text data of the prompt sentence and the plurality of information source candidate data items into embedding vector data, to calculate a relevance evaluation value for each of the plurality of information source candidate data items based on similarity between corresponding embedding vector data, to select, as contextually citable information source data, information source candidate data items having a relevance evaluation value that is equal to or greater than a predetermined threshold, to cause the generative AI model to generate summary information of the selected information source data, and to format and transmit response data including the selected information source data and the summary information to the user terminal. This enables an improved computer-implemented information retrieval process in which the server integrates generative AI-based semantic analysis with vector-based relevance evaluation and structured response generation, thereby technically enhancing the accuracy, efficiency, and contextual suitability of information source selection while reducing processing of irrelevant data and improving overall system performance.

The term “system” refers to an arrangement of one or more computing devices and associated software components configured to execute the processing described herein.

The term “processor” refers to one or more hardware processing units, such as a central processing unit or a graphics processing unit, capable of executing instructions stored in a memory to perform logical and arithmetic operations.

The term “user terminal” refers to an electronic device operated by a user, such as a personal computer, a smartphone, or a tablet device, that is configured to transmit a prompt sentence to the server and to receive and display response data.

The term “prompt sentence” refers to text data input by a user via the user terminal, the text data representing a request, query, or instruction that specifies content to be analyzed or information to be retrieved.

The term “generative AI model” refers to a machine-learned model that generates or transforms text or other data based on input data, and that is configured to perform natural language processing on the prompt sentence to output analysis result data including keywords and concepts.

The term “natural language processing” refers to computation performed on human language text, including operations such as tokenization, part-of-speech tagging, parsing, semantic analysis, keyword extraction, and concept identification.

The term “analysis result data” refers to structured information produced by the generative AI model in response to the prompt sentence, the structured information including at least keywords and concepts that represent semantic features of the prompt sentence.

The term “keyword” refers to a term or phrase extracted from the prompt sentence or related text that represents a salient topic, subject, or entity used for search or relevance evaluation.

The term “concept” refers to an abstract idea, theme, or semantic category derived from the prompt sentence or related text that characterizes underlying meaning beyond individual words.

The term “information source storage” refers to one or more data repositories storing records of information sources, such as databases, indexes, or file systems that maintain metadata, text, and identifiers for documents or other content.

The term “search query data” refers to a representation of a search request generated by the processor based on the analysis result data, the search request being suitable for submission to the information source storage to retrieve information source candidate data items.

The term “information source candidate data item” refers to data representing a potential information source retrieved from the information source storage in response to the search query data, the data including at least an identifier and text content such as a title or summary.

The term “relevance evaluation processing” refers to processing performed by the processor to compute a relevance evaluation value for each information source candidate data item based on a relationship between the information source candidate data item and the prompt sentence or the analysis result data.

The term “relevance evaluation value” refers to a numerical or ordinal measure indicating a degree of contextual consistency or semantic similarity between an information source candidate data item and the prompt sentence or the analysis result data.

The term “predetermined threshold” refers to a reference value stored in a memory or configuration that is used to decide whether a relevance evaluation value is sufficient for an information source candidate data item to be selected as contextually citable.

The term “contextually citable information source data” refers to information source candidate data items that satisfy the predetermined threshold for the relevance evaluation value and are therefore considered suitable for citation in the context specified by the prompt sentence.

The term “embedding vector data” refers to numerical vector representations of text generated by a machine-learned model, each vector representing semantic characteristics of the corresponding text in a continuous vector space.

The term “similarity” refers to a quantitative measure of closeness between two pieces of embedding vector data, computed by a mathematical function such as cosine similarity, inner product, or Euclidean distance.

The term “summary information” refers to text generated by the generative AI model that concisely describes the content of an information source candidate data item or selected information source data.

The term “response data” refers to data formatted by the processor for transmission to the user terminal, the data including at least selected contextually citable information source data and optionally the summary information and analysis result data.

In one embodiment, a server cooperates with a terminal operated by a user to implement the claimed system. The server includes at least one hardware processor, a main memory, a non-volatile storage device, and a network interface. The server executes an operating system, such as a general-purpose server operating system, and an application program that implements an information-source selection service. The terminal includes a hardware processor, a display, an input device, a memory, and a communication module, and executes a client application such as a web browser or a native application.

The user operates the terminal to input a prompt sentence as plain text. The terminal provides a text input area on a graphical user interface and displays a button for submitting the prompt sentence. For example, the user may input the prompt sentence “Advances in AI-based medical diagnosis, especially in radiology and pathology, and their impact on clinical workflows.” The terminal stores the input text in a buffer in main memory and transmits the prompt sentence to the server via a communication protocol such as HTTPS, using a request message that contains the prompt sentence in a text field.

The server receives the request via the network interface and passes the request to an application program running on the server processor. The server parses the received data and stores the prompt sentence in a memory region associated with a session for the user. The server normalizes the prompt sentence by performing operations such as character encoding normalization, removal of control characters, and optional language detection, using string-processing libraries in the application program.

The server uses a generative AI model as a natural language processing component to analyze the prompt sentence. In one embodiment, the server deploys a neural network model of the transformer architecture on a computing node that includes at least one graphics processing unit. The generative AI model includes multiple transformer layers, each layer including multi-head self-attention blocks, feedforward sublayers, layer normalization components, and residual connections. The server stores model parameters, such as weight matrices of attention and feedforward layers, in a model storage area accessible to the processor and the graphics processing unit.

The server converts the prompt sentence into a sequence of token identifiers by using a tokenizer stored in memory. The tokenizer maps sequences of characters into subword units according to a predefined vocabulary. The server then converts each token identifier into an initial embedding vector by indexing into an embedding matrix. The server adds positional encodings to the embedding vectors to indicate token positions. The server inputs the sequence of embedding vectors into the transformer layers of the generative AI model. Each transformer layer computes attention scores between tokens, applies softmax functions to normalize these scores, and calculates weighted sums of value vectors. The server propagates the resulting vectors through feedforward networks, using non-linear activation functions such as rectified linear units or Gaussian error linear units, and performs layer normalization and residual addition.

The server configures the generative AI model to output structured analysis result data instead of free-form text. For example, the server applies an output head that classifies tokens into categories such as “keyword,” “concept indicator,” and “context marker,” and that generates probability distributions over a controlled vocabulary of candidate keywords and concepts. The server applies a decoding algorithm that selects tokens or phrases with probabilities above a threshold and groups them into keyword phrases and concept labels. As a result, the server obtains analysis result data that includes at least a list of keyword strings and a list of concept strings derived from the prompt sentence.

The server stores the analysis result data in a structured data object in memory. The server may represent the data as a record that includes fields for keywords, concepts, and optionally additional metadata such as confidence scores or semantic categories. For example, for the above prompt sentence, the server may store keywords such as “AI-based medical diagnosis,” “radiology,” “pathology,” “deep learning,” and “clinical workflow,” and concepts such as “medical imaging,” “diagnostic accuracy,” and “workflow optimization.”

The server uses the analysis result data to generate search query data for an information source storage. The server constructs a query object that includes logical combinations of keywords and concepts, weight coefficients for each term, and optional filters for publication date, document type, and language. In one embodiment, the server uses a full-text search engine executing on the same or a separate computing device, and the search query data follows an internal query language supported by the search engine. The server maps each keyword and concept to fields such as title, abstract, and body text, and assigns higher weights to fields that are more important for contextual matching.

The server transmits the search query data to the information source storage, which may include a database system and an index structure such as an inverted index. The information source storage uses the query data to locate document identifiers whose indexed terms match the query terms, and calculates initial relevance scores using statistical ranking algorithms such as term frequency-inverse document frequency or language models. The information source storage returns a set of information source candidate data items to the server. Each item may include a document identifier, a title, a summary or abstract, a uniform resource locator, a publication date, and the initial relevance score.

The server receives the information source candidate data items and stores them in a list structure in memory. The server then performs relevance evaluation processing that uses embedding vector data to refine the selection. The server uses a sentence embedding model, which may be a neural network encoder, to convert text data into embedding vector data. In one embodiment, the server uses a transformer-based encoder that accepts a sequence of tokens and outputs a fixed-dimensional vector representing the semantic content of the text. The server inputs the prompt sentence to the encoder and stores the resulting embedding vector as a query embedding. The server similarly inputs text derived from each information source candidate data item, such as a concatenation of the title and abstract, to the encoder to obtain a document embedding for each candidate.

The server calculates similarity measures between the query embedding and each document embedding. The server may compute cosine similarity by normalizing each vector to unit length and calculating the dot product. The server uses the similarity value as at least part of the relevance evaluation value. The server may combine the embedding-based similarity with the initial relevance score from the information source storage, using a weighted sum or another aggregation function predetermined in configuration data. The server obtains a relevance evaluation value for each information source candidate data item and compares the value with a predetermined threshold stored in memory.

The server selects as contextually citable information source data only those items whose relevance evaluation value is equal to or greater than the predetermined threshold. The server may reorder the selected items in descending order of relevance evaluation value. The server stores the selected items as a new list structure. Because the server uses embedding vector similarity in addition to keyword matching, the server can distinguish between information sources that share similar words but differ in semantic context, and can prioritize sources whose content more closely matches the conceptual structure of the prompt sentence.

The server uses the generative AI model to generate summary information for at least some of the selected information source data. The server provides the title and abstract of a selected information source as input text to the generative AI model, together with an instruction to generate a concise summary of the content within a specified length. The server uses the same transformer architecture as described above, but configures the output head to perform conditional text generation. The server decodes output tokens by using algorithms such as greedy decoding or beam search, and stops generation when reaching an end-of-sequence token or a maximum token limit. The server obtains a summary text that describes the main points of the information source in a compressed form.

The server formats response data that includes at least the selected contextually citable information source data and the corresponding summary information. The server includes fields such as the title, summary, and a link for each information source. The server transmits the response data to the terminal over the network. The terminal receives the response data, updates a display buffer, and presents a list of information sources and summaries on the display. The user can select an information source from the list, and the terminal can open the link using a browser component or a viewer component.

The described configuration improves computer technology in multiple respects. The server does not simply automate human reading and selection; the server implements a specific pipeline that transforms unstructured text input into structured analysis result data, vector representations, and refined result sets by using integrated neural network models and similarity computations. The server reduces processing of irrelevant data by performing early semantic filtering based on the analysis result data and later fine-grained selection based on embedding similarities. This reduces communication load between the server and the information source storage because the server can limit the number of documents for which detailed processing is required. The server also reduces the amount of data transmitted to the terminal by sending only contextually citable information sources and compact summaries.

The server achieves technical effects such as increased precision of retrieved information sources, reduced latency for users, and lower computational load on the search engine. Because the server uses a transformer-based generative AI model to output structured analysis result data, the server can generate search query data that more accurately captures semantic intent than simple keyword extraction. Because the server uses embedding vector similarity for relevance evaluation, the server can rank candidates by semantic closeness in a high-dimensional vector space, which leads to fewer false positives and fewer missed relevant sources. The causal relationship is that more informative and structured internal representations of the prompt sentence lead to more focused querying and more discriminative scoring, which in turn leads to faster convergence to a small, high-quality set of results.

The server configures the generative AI model through a training process performed prior to deployment. During training, the server or another computing device uses a corpus of text data that includes pairs of prompt sentences and corresponding sets of keywords and concepts, and possibly labels indicating contextual relevance between pairs of prompts and documents. The server initializes model parameters randomly or from a pre-trained language model, defines a loss function such as cross-entropy for classification outputs and negative log-likelihood for generated text, and uses a gradient-based optimization algorithm such as stochastic gradient descent with adaptive learning rates to update the parameters. The server may apply regularization techniques such as dropout and weight decay, and data augmentation techniques such as random cropping of sentences or synonym replacement, to improve generalization.

The server stores the trained model parameters in non-volatile memory and loads them into main memory when starting the service. The server may further fine-tune the sentence embedding encoder using a contrastive learning objective, where the server minimizes distance between embeddings of semantically similar text pairs and maximizes distance between embeddings of dissimilar pairs. This training process improves the density and discriminative power of the embedding space, thereby enhancing relevance evaluation accuracy.

The system differs from conventional rule-based or human-centric workflows because the server uses non-intuitive, high-dimensional embeddings and attention-based context aggregation, which are not easily replicated by manual processes. The server applies specific non-conventional procedures, such as using generative AI-derived analysis result data to construct multi-field weighted search queries, and then applying embedding-based similarity as a second-stage filter. This two-stage approach reduces index load, minimizes unnecessary disk input/output operations at the search engine, and reduces memory consumption for candidate handling.

In alternative embodiments, the server may adjust the architecture of the generative AI model, such as changing the number of transformer layers, the dimensionality of embedding vectors, or the number of attention heads, depending on hardware capabilities and required accuracy. The server may implement the sentence embedding encoder as a separate model trained specifically for sentence similarity, or reuse part of the generative AI model. The server may store embedding vectors for frequently accessed documents in a vector index structure, such as a tree or graph-based approximate nearest neighbor index, to accelerate similarity searches. The server may distribute processing across multiple server nodes, with one node dedicated to generative AI analysis and another node dedicated to search and relevance evaluation, thereby improving scalability.

In another embodiment, the server may integrate additional signals, such as document quality scores or domain trust levels, into the relevance evaluation value. The server can store these signals in auxiliary tables in the information source storage and retrieve them together with candidate data. The server can adjust the predetermined threshold and weight coefficients dynamically based on system load, historical performance statistics, or user feedback, thereby controlling trade-offs between precision and recall.

The described embodiments demonstrate that the system is implemented as a specific combination of hardware and software components executing concrete data processing operations on defined data structures, rather than as an abstract idea. The server uses a generative AI model and embedding computations not merely to automate human decision-making, but to improve the internal operation of a computer system that retrieves and processes large volumes of information sources.

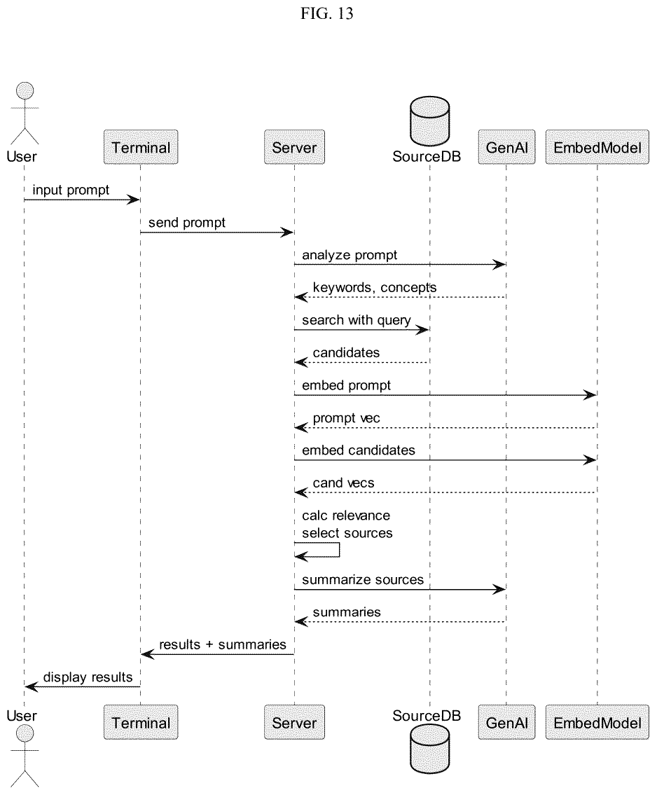

The following describes the processing flow using FIG. 13.

### Step 1

The user operates the terminal to input a prompt sentence.
The user views a text input field displayed by the terminal on a graphical user interface and types a prompt sentence such as “Advances in AI-based medical diagnosis, especially in radiology and pathology, and their impact on clinical workflows.” The user then activates a submit control, such as pressing an enter key or tapping a send button.
Input: The user provides natural language text as the prompt sentence.
Output: The terminal stores the prompt sentence as a text string in a memory buffer and prepares the text for transmission to the server.

### Step 2

The terminal transmits the prompt sentence to the server.
The terminal embeds the prompt sentence into a request message, for example as a text field in a structured payload, and attaches session identifiers or authentication tokens if needed. The terminal sends the request via a network stack using a communication protocol such as HTTPS.
Input: The terminal uses the stored prompt sentence string as input to a communication module.
Output: The terminal outputs a network packet stream containing the prompt sentence, which is delivered to the server over a communication network.

### Step 3

The server receives and validates the prompt sentence.
The server accepts the incoming request through a network interface and passes it to an application process. The server parses the payload to extract the prompt sentence string and performs validation checks such as verifying that the length is within limits and that the text encoding is valid. The server may normalize the text by converting character encodings and removing invalid characters.
Input: The server receives the request data stream containing the prompt sentence.
Output: The server produces a cleaned and validated prompt sentence string stored in main memory for further processing.

### Step 4

The server tokenizes the prompt sentence and prepares it for analysis by the generative AI model.
The server applies a tokenizer that maps the prompt sentence string to a sequence of token identifiers based on a predefined vocabulary. The server converts each token identifier into an embedding vector by indexing into an embedding matrix stored in memory, and adds positional encodings to represent token order.
Input: The server uses the validated prompt sentence string as input to the tokenizer.
Output: The server generates a sequence of embedding vectors representing the prompt sentence, which is used as input to the generative AI model.

### Step 5

The server analyzes the prompt sentence using the generative AI model to obtain analysis result data.
The server feeds the sequence of embedding vectors into a transformer-based generative AI model that consists of multiple layers of multi-head self-attention and feedforward networks. The server executes matrix multiplications and attention weight calculations to propagate activations through the network. The server applies an output head configured for classification and extraction so that the model assigns probabilities to candidate keywords and concepts and marks their positions in the sequence. The server decodes the model output to extract keyword phrases and concept labels that exceed specified probability thresholds.
Input: The server provides the embedding vector sequence to the generative AI model as input.
Output: The server obtain analysis result data, including a list of keywords and a list of concepts, which are stored as structured data in memory.

### Step 6

The server generates search query data for an information source storage based on the analysis result data.
The server reads the keywords and concepts from the analysis result data and constructs a query object that includes search terms, field mappings, and weight values. The server assigns higher weights to primary keywords and lower weights to auxiliary terms, and optionally applies filters, such as publication date ranges and language constraints. The server formats the query object according to the query language or API used by the information source storage.
Input: The server uses the structured analysis result data (keywords and concepts) as input.
Output: The server produces search query data in a structured format suitable for submission to the information source storage.

### Step 7

The server transmits the search query data to the information source storage and retrieves information source candidate data items.
The server sends the search query data to a search engine or database system through a client library or a network interface. The information source storage executes index lookups and scoring algorithms, then returns records that satisfy the query conditions. The server receives these records and converts them into a list of information source candidate data items, each including fields such as title, abstract, identifier, and initial relevance score.
Input: The server provides the search query data to the information source storage.
Output: The server receives and stores a list of information source candidate data items as a structured collection in memory.

### Step 8

The server encodes the prompt sentence and the information source candidate data items into embedding vector data.
The server uses a sentence embedding model to convert text segments into fixed-dimensional vectors. The server inputs the validated prompt sentence text into the encoder to obtain a query embedding. The server then constructs text representations for each candidate, for example by concatenating the title and abstract, and inputs each representation into the encoder to obtain a document embedding for each candidate. The encoding process includes tokenization, embedding lookup, transformation through neural network layers, and pooling operations to produce a single vector per text segment.
Input: The server uses the prompt sentence text and the text portions (such as titles and abstracts) of the information source candidate data items as input.
Output: The server generates one query embedding vector and a set of document embedding vectors corresponding to the candidate items.

### Step 9

The server calculates a relevance evaluation value for each information source candidate data item.
The server computes a similarity measure, such as cosine similarity, between the query embedding and each document embedding by performing vector normalization and dot product operations. The server optionally combines this similarity value with the initial relevance score received from the information source storage by computing a weighted sum or other aggregation function. The server assigns the resulting numerical value as the relevance evaluation value for the corresponding candidate.
Input: The server uses the query embedding vector, the document embedding vectors, and optionally the initial relevance scores as input data.
Output: The server produces a relevance evaluation value for each information source candidate data item and stores these values alongside the candidate records.

### Step 10

The server selects contextually citable information source data based on the relevance evaluation values.
The server compares each relevance evaluation value with a predetermined threshold and marks candidates whose values meet or exceed the threshold as selected items. The server may also sort the selected items by descending relevance evaluation value to determine a ranking order. The server compiles the selected and ranked items into a new list representing contextually citable information source data.
Input: The server uses the candidate list with associated relevance evaluation values and the predetermined threshold as input.
Output: The server outputs a filtered and ranked list of contextually citable information source data stored in memory.

### Step 11

The server generates summary information for the selected information source data using the generative AI model.
The server extracts text fields, such as titles and abstracts, from each selected information source and constructs an input sequence that includes these fields and an instruction to generate a concise summary. The server tokenizes this input and feeds it into the generative AI model configured for conditional text generation. The server executes the model to produce output token sequences, using decoding techniques like greedy decoding or beam search, and then converts the token sequences back into summary text.
Input: The server uses the text content of the selected information source data and control instructions as input to the generative AI model.
Output: The server obtains summary information for each selected information source and associates each summary with the corresponding source record.

### Step 12

The server formats response data and transmits the response to the terminal.
The server constructs a response object that includes data fields such as the original prompt sentence, the list of selected information sources, and the generated summaries. The server organizes this data into a structured format and attaches metadata such as ordering information and relevance scores. The server then sends the response object through the network interface using a communication protocol such as HTTPS.
Input: The server uses the contextually citable information source data, the associated summary information, and the prompt sentence as input.
Output: The server outputs a response message containing formatted response data transmitted to the terminal.

### Step 13

The terminal receives the response data and displays the information sources to the user.
The terminal accepts the response message via its network communication module and parses the structured data to extract the list of information sources and summaries. The terminal updates the user interface to render a list view that shows titles, summaries, and selectable controls for each source. The terminal may also display the prompt sentence as a header or context indicator.
Input: The terminal receives the response message containing the formatted response data from the server.
Output: The terminal produces a visual presentation on the display that allows the user to review and select contextually citable information sources.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional information recommendation systems, reference selection and ranking for scholarly or technical content are typically performed using simple keyword matching, static relevance scores, or manually tuned rules. Such systems suffer from several technical limitations. First, the systems often rely on a single analysis pipeline and cannot efficiently integrate heterogeneous signals such as deep semantic understanding, citation frequency information from external databases, and dynamic user state. As a result, the ranking logic becomes rigid and difficult to scale when new types of signals are introduced. Second, traditional architectures treat user context and user emotion, if considered at all, as superficial filters applied after ranking, rather than as core inputs to the scoring computation itself. This leads to inefficient use of computational resources, because many items are fully analyzed and ranked without regard to whether they are suitable for the user's current state. Third, when a large number of candidate information resources must be evaluated, repeated execution of complex natural language processing tasks and database queries causes latency and computational overhead, and the system cannot be updated in real time in response to changes in the user's reading position or emotional state. Fourth, existing systems that attempt to use machine-learned models such as large language models often invoke such models in an ad hoc manner, without a structured prompt design or integration with numeric scoring and external citation data, reducing the reproducibility and controllability of the output and making it difficult to guarantee consistent ranking behavior.

There is therefore a need for a computer-implemented technique that improves the way a processor analyses text-based information resources, queries and fuses multiple data sources including external citation databases, and computes and updates ranking scores in a manner that is both semantically rich and computationally efficient. In particular, there is a need for an improved architecture in which (i) a generative AI model is driven by explicitly constructed prompt sentences to perform natural-language analysis of documents and candidate resources; (ii) numeric indices such as relevance scores and citation frequencies are systematically integrated with model-generated ranking results; and (iii) a user emotional state obtained from multi-modal signals is incorporated into the core scoring function so that a recommended information resource set can be dynamically updated in real time. By addressing these issues, the invention aims to improve the functioning of the computer system itself, for example by reducing unnecessary model calls and database accesses, by enabling more efficient ranking updates conditioned on user emotion and reading situation, and by providing a structured interface between generative AI components and traditional scoring and retrieval modules.

The specific processing by the specific processing unit 290 of the data processing device 12 in Application Example 2 is realized by the following means.

The present invention provides a server comprising a processor configured to input a prompt sentence to a generative AI model in order to cause the generative AI model to execute an analysis process using natural language processing on content of a text-based information resource and obtain an analysis result, to obtain candidate related information resources that are contextually citable from a related information set based on the analysis result and phrase information extracted from the information resource, to calculate a relevance score for each of the candidate related information resources and select candidate related information resources whose relevance scores are equal to or greater than a predetermined threshold, to obtain citation frequency information for the selected candidate related information resources from an external information storage and calculate an evaluation index based on the citation frequency information and the relevance scores and rank the candidate related information resources according to the evaluation index, to estimate a user emotional state based on image information, voice information, or text information acquired from a user terminal, to identify a recommended information resource set suitable for the user emotional state by weighting or correcting the evaluation index or the ranking result according to the user emotional state, and to transmit the recommended information resource set and selection reason information to the user terminal so that the recommended information resource set is displayed on the user terminal. This enables the computer system to improve internal operation by combining structured prompt-driven analysis by the generative AI model with numeric relevance and citation computations, by incorporating user emotion directly into the ranking computation, and by dynamically updating and outputting a recommended information resource set with reduced latency and improved efficiency compared with conventional systems that do not tightly integrate these heterogeneous processing components.

The term “processor” refers to a hardware computing element, such as a central processing unit or other programmable computation unit, that executes machine-readable instructions to perform data processing operations described in the system.

The term “text-based information resource” refers to any electronically stored content in which primary information is represented as character data, including but not limited to articles, papers, reports, web pages, and other document-like digital content.

The term “generative AI model” refers to a machine-learned computation model that receives an input including a prompt sentence and generates output text or structured data based on statistical relationships learned from training data, and that is capable of performing natural language analysis and generation.

The term “prompt sentence” refers to a sequence of characters included in an input to the generative AI model that specifies, in natural language or a structured instruction format, a task to be executed by the generative AI model with respect to given input data.

The term “analysis result” refers to information output by the generative AI model or by other natural language processing components that describes semantic, syntactic, or structural characteristics of the text-based information resource, including but not limited to summaries, extracted phrases, topics, or classification labels.

The term “phrase information” refers to one or more linguistic units extracted from the text-based information resource, such as words, terms, key phrases, or named entities, that are used as features for retrieval or scoring of related information resources.

The term “related information set” refers to a collection of information resources stored in a storage system or accessible via a communication network, which are candidates to be evaluated as contextually related to the text-based information resource.

The term “candidate related information resource” refers to an information resource selected from the related information set based on initial matching or similarity to the text-based information resource, prior to final ranking and recommendation.

The term “relevance score” refers to a numerical value computed for each candidate related information resource that quantitatively indicates a degree of contextual or semantic relevance between the candidate related information resource and the text-based information resource.

The term “predetermined threshold” refers to a value stored in a memory or determined according to a rule, with which the relevance score is compared in order to decide whether a candidate related information resource is to be selected or discarded.

The term “citation frequency information” refers to numerical data representing how many times an information resource has been cited or referenced by other information resources, obtained from an external storage such as a citation database.

The term “external information storage” refers to a storage apparatus or a remote database system accessible via a communication interface, which stores citation data or other metadata about information resources separately from the server.

The term “evaluation index” refers to a composite numerical indicator calculated from at least the relevance score and the citation frequency information, and optionally other features, used to rank the candidate related information resources.

The term “ranking” refers to an operation in which candidate related information resources are ordered in accordance with the evaluation index so that higher-ranked items are considered more preferable or relevant.

The term “user terminal” refers to an end-user device including at least one user interface, such as a mobile device, a head-mounted display device, a personal computer, or another computing terminal capable of communicating with the server.

The term “image information” refers to digital data representing visual information acquired by an image sensor of the user terminal, including still images or sequences of images that capture a user's face or body.

The term “voice information” refers to digital data representing audio signals acquired by a sound sensor of the user terminal, including the user's speech or other sounds.

The term “text information” refers to digital character data input or generated at the user terminal, including user queries, comments, or other text entered by the user or produced by applications.

The term “user emotional state” refers to a representation of affective conditions of a user, such as confusion, excitement, boredom, or interest, estimated from one or more of image information, voice information, and text information.

The term “recommended information resource set” refers to a subset of information resources selected from the candidate related information resources according to the evaluation index and the user emotional state, and designated for presentation to the user.

The term “selection reason information” refers to data describing, in natural language or structured form, why each information resource in the recommended information resource set has been selected, including references to relevance, citation frequency, or user emotional state.

The term “summary information” refers to a condensed textual description of main contents of the text-based information resource, generated by the generative AI model or another analysis component.

The term “important phrase information” refers to a subset of phrase information that has been determined, by analysis of the text-based information resource, to be especially indicative of the main concepts or topics of the resource.

The term “information on types of citation targets” refers to data specifying categories or roles of references that are appropriate for citation, such as introductory material, technical background, methodological references, or state-of-the-art references.

The term “recommendation conditions” refers to parameters or constraints used when selecting or ranking information resources, including but not limited to desired difficulty level, freshness, topic focus, or suitability for a given user emotional state.

The term “reading situation of the user” refers to a state of interaction between the user and the text-based information resource, including at least a current position within the resource, a progress level through the resource, and the current user emotional state.

In one embodiment, a server implements the claimed system as a network-accessible computing apparatus that cooperates with one or more terminals used by a user. The server includes at least one processor, a main memory, a non-volatile storage device, a communication interface, and optionally a specialized accelerator such as a graphic processing device. The terminal includes at least one processor, a display unit, an input unit, an image sensor, and a sound sensor. The user operates the terminal to view text-based information resources, such as scientific papers, technical reports, and web articles.

The server executes a program stored in the non-volatile storage device. The program is implemented, for example, in a general-purpose programming language and runs on an operating system. The server uses a natural language processing library, such as a typical dependency-parsing framework, a tokenization module, and a topic extraction module, to perform classical linguistic analysis. Concretely, the server can use a tokenization and part-of-speech tagging engine, a morphological analysis library, and a syntactic dependency parser to process text. The server additionally uses a numerical computation library, such as a matrix operation library and a scientific computing framework, for feature extraction and scoring.

The server prepares and manages data structures specific to this system. For example, the server stores each text-based information resource as a record including a document identifier, raw text, normalized text, token sequence, sentence boundaries, and paragraph boundaries. The server stores a related information set as a collection of records including an identifier, a title string, an abstract string, a feature vector, and citation metadata. The server stores user-related information including a user identifier, historical interaction logs, and time-stamped emotional state estimates.

The server employs a generative AI model as a large-scale neural network trained for language understanding and generation. In one embodiment, the server deploys a transformer-based architecture having multi-head self-attention layers, position-wise feed-forward layers, residual connections, and layer normalization. The model parameters are represented as numerical weight matrices and bias vectors stored in model parameter files. The server loads the generative AI model into memory or accesses it via an external model serving endpoint over the network. The server inputs a prompt sentence and additional context as sequences of token identifiers, and receives probability distributions over subsequent tokens, which the server decodes into output text or structured responses.

The server generates prompt sentences according to predetermined templates and rules. For example, the server generates a prompt sentence that includes a summary of the user's current document, a description of the task, and a list of candidate resources. The server uses character strings and control tokens to delimit sections of the prompt.

One example of a prompt sentence for document understanding is:
“You are an expert in artificial intelligence and natural language processing. Read the following text and:
1) Summarize the main topic in 3 sentences.
2) List 10 important technical keywords.
3) List 5 types of academic sources that should be cited contextually.

Text: <<document_excerpt>>”

Another example of a prompt sentence for candidate evaluation is:
“You are helping a researcher choose references for an article about ‘Evolution of Natural Language Processing by AI’.
Here is the article summary: <<summary>>
Here are candidate references with citation counts: <<list_of_candidates>>
Please:
1) Select the 10 most contextually appropriate references.
2) Rank them from 1 (best) to 10.
3) For each, write a one-sentence explanation of why it is appropriate.”

The server configures the generative AI model to output a constrained format by including instructions in the prompt sentence. For example, the server requests that the generative AI model output JSON-like sections or numbered lists, enabling the server to parse the response deterministically. The server defines and uses parsing rules that map specific textual markers in the response to internal data structures (e.g., arrays of keywords, arrays of ranked reference identifiers).

The server performs multi-stage scoring that integrates model output with numeric computations. In one embodiment, the server calculates a relevance score between the analyzed information resource and each candidate related information resource. The server computes a term-frequency-inverse-document-frequency (TF-IDF) vector for the information resource and for each candidate and then computes a cosine similarity value using a linear algebra library. The server also computes a contextual similarity using a dense embedding vector produced by a sentence-level encoder network. The server obtains candidate vectors by feeding sentences or abstracts into a pre-trained encoder neural network, such as a transformer with a pooling layer, and extracting the hidden state from the final encoder layer. The server then computes cosine similarity between the document embedding and each candidate embedding.

The server obtains citation frequency information from an external information storage. In one embodiment, the server sends network requests to a citation database system using a communication protocol and retrieves a citation count for each DOI or title. The server caches citation data in its storage device to reduce repeated network access. The server normalizes citation frequencies by publishing year, for example by dividing the citation count by the number of years since publication plus a small constant, and then scales the normalized values into a bounded range.

The server computes an evaluation index by combining relevance scores and citation frequency information. For example, the server calculates:
evaluation_index=w1*normalized_relevance+w2*normalized_citation
where w1 and w2 are weights stored in a configuration file or determined empirically. The server uses a vector sorting algorithm, such as a quick-sort or a heap-based partial sort, to order the candidate related information resources by the evaluation index.

The server estimates the user emotional state using multi-modal inputs. The terminal captures image information via a camera and voice information via a microphone and sends these signals, or extracted features thereof, to the server. Alternatively or additionally, the terminal or the server executes an emotion recognition model. In one embodiment, the terminal runs a convolutional neural network on the facial image stream to detect facial landmarks and then feeds normalized landmark coordinates into a fully connected network that outputs emotion probabilities. In another embodiment, the server processes voice information using a recurrent neural network or transformer-based acoustic model to derive features such as pitch contour and energy and outputs probabilities for discrete emotions. The server also analyzes user-generated text using a sentiment analysis module based on a neural network.

The server aggregates the outputs of these classifiers to produce a user emotional state representation, such as a vector of scores for labels like “confused”, “excited”, or “bored”. The server stores these vectors periodically to maintain a temporal profile of the user's emotions.

The server modifies the evaluation index or ranking result based on the user emotional state. For example, the server defines an emotion weighting function that maps a pair of an emotion label and a reference type (e.g., survey, tutorial, research article) to a numeric adjustment. When the user is classified as “confused”, the server increases the score of references labeled as “introductory” or “tutorial” and decreases the score of highly specialized references. When the user is classified as “excited”, the server boosts the score of cutting-edge or high-impact references. The server computes an emotion-adjusted score:
emotion_adjusted_score=evaluation_index+f(emotion_state, reference_type)
where f is implemented as a small look-up table or as a trained multilayer perceptron that takes as input a concatenation of the evaluation index and a one-hot encoding of the emotion label and outputs a scalar adjustment. The server ranks references by the emotion_adjusted_score.

In one embodiment, the server uses the generative AI model again to refine emotion-aware recommendations. The server generates a prompt sentence that explicitly includes the user emotional state and recommendation criteria. An example of such a prompt sentence is:
“The user is currently confused about the ethical aspects of AI.
Here is the article summary: <<summary>>
Here are candidate references with citations and difficulty levels: <<candidate_list>>
Please select 5 beginner-friendly, highly cited references that will help resolve confusion, and explain each choice in simple language.”

The server feeds the candidate list and emotional context into the generative AI model. The server then uses parsing rules to interpret the model's recommended subset and reasons and combines this with the emotion-adjusted numeric scores. This hybrid approach, in which neural ranking is not used in isolation but combined with deterministic scoring, improves repeatability and control and avoids unbounded or non-deterministic behavior.

The server transmits the recommended information resource set and selection reason information to the terminal over the network using a message format such as JSON. The terminal receives the data and uses a user interface framework to render the recommendations. The terminal displays titles, citation counts, short descriptions, and labels such as “Introductory” or “Advanced” on the display. The user can select an item to open an associated document or web page.

In another embodiment, the server updates recommendations dynamically according to the user's reading situation. The terminal periodically transmits the current reading position and scroll offset to the server. The server limits processing to the currently visible section rather than re-analyzing the entire document, thereby reducing computational cost. The server incrementally updates topic vectors and candidate lists only for the changed section, avoiding redundant full-document processing. This section-based recomputation, together with caching of intermediate features and citation data, reduces latency and network usage compared with conventional systems that recompute scores globally for each update.

The combined architecture, in which classical feature extraction, generative AI analysis, citation retrieval, and emotion-based adjustment are tightly integrated, provides technical advantages. The server reduces the number of calls to the generative AI model by using the model for high-level analysis and ranking only after simpler filters and numeric scoring reduce the candidate set. This selective invocation decreases processing time and network bandwidth usage. The server improves accuracy of reference selection by combining dense semantic similarity, citation-based reliability, and emotion-aware weighting, which cannot be feasibly replicated with simple keyword rules or manual human processing at comparable scale and latency. The server also improves data management by maintaining coherent internal identifiers, caching citation and embedding data, and structuring prompt sentences to preserve context without repeatedly sending full documents over the network.

The generative AI model itself is trained using supervised or self-supervised learning on large corpora of text. In one embodiment, the server or an external training environment initializes the model with random weights and trains it using a transformer architecture. The training process minimizes a loss function such as cross-entropy between predicted and actual tokens using gradient descent with an adaptive optimizer. During training, the system conducts data augmentation by varying input sequences, masking tokens, and shuffling segments to improve generalization. For the emotion model, the system uses a labeled data set of facial expressions, voice recordings, or texts with emotion labels and trains a convolutional or recurrent network using a categorical cross-entropy loss. The server stores the resulting model parameters and uses them at inference time.

The server implements non-conventional control logic for integrating these learned models. The server does not simply replace human judgment with machine judgment; instead, the server defines specific non-human criteria, such as multi-objective scoring that simultaneously incorporates semantic relevance, citation authority, and emotional suitability. The server uses vectorized operations and batched requests for both the generative AI model and the citation database, which directly improves computational efficiency. For example, the server processes candidate abstracts in batches, thus making more effective use of vector processors and reducing per-document overhead.

The terminal and server cooperate in a manner that extends beyond generic data acquisition-analysis-display. The terminal performs pre-processing on sensor data, such as down-sampling video frames and extracting regions of interest for facial analysis, before sending features to the server. This reduces uplink bandwidth and allows the server to focus resources on feature-level processing. The terminal also caches recommendation results locally to avoid redundant network calls when the user revisits previous sections.

In a variation of the embodiment, the server executes all emotion estimation locally using data streams from the terminal. In another variation, the server executes the generative AI model on dedicated hardware within the same data center, whereas in another implementation the generative AI model is provided by an external service. In yet another alternative, the server uses a different network architecture for the language model, such as a recurrent neural network with attention or a convolutional sequence model, instead of a transformer. The core control logic remains the same: the server constructs structured prompt sentences, obtains analysis results, integrates numeric scores, applies emotion-aware weighting, and generates recommendations.

In a further embodiment, the server uses alternative feature extraction methods, such as graph-based representations of citation networks or topic graphs, to compute relevance indices. The server may compute PageRank-like scores for references within a citation graph and incorporate such graph-theoretic measures into the evaluation index. This further enhances the ability of the system to surface authoritative and contextually appropriate information with high precision.

Because the server structures and sequences these operations in a specific way—pre-filtering, prompt-based generative analysis, numeric scoring, emotion-based adjustment, and targeted updates based on the reading situation—the system achieves improved processing speed, more accurate results, reduced network and computation load, and stable, reproducible behavior. These improvements are attributable to concrete technical arrangements of hardware and software modules, data structures, and algorithms, and therefore amount to an improvement in the functioning of the computer system itself rather than an abstract automation of human decision-making.

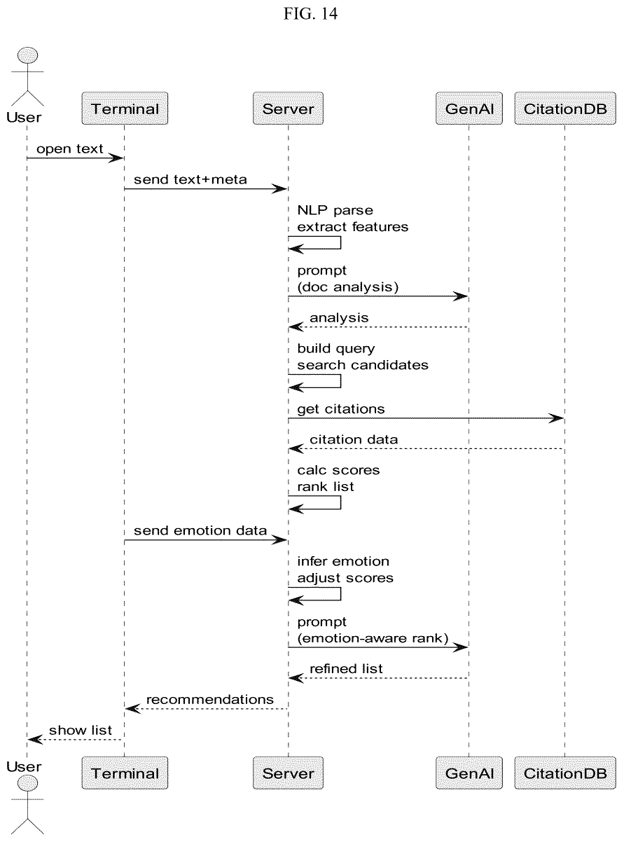

The following describes the processing flow using FIG. 14.

### Step 1

User operates the terminal to select or open a text-based information resource.
Terminal receives, as input, a user selection such as a file path, a URL, or pasted text.
Terminal extracts the raw text content and basic metadata (for example, title string, resource identifier, and current reading position) using a document rendering component or a browser component.
Terminal generates, as output, a data packet including the raw text, metadata, and a session identifier.

### Step 2

Terminal transmits the data packet to the server.
Terminal uses, as input, the data packet generated in Step 1.
Terminal sends the data packet to the server over a network interface using a request message and waits for a response.
Terminal generates, as output, a network request received by the server that contains the text-based information resource and associated metadata.

### Step 3

Server receives and stores the text-based information resource.
Server uses, as input, the network request from the terminal that includes the raw text and metadata.
Server validates the packet structure, assigns a document identifier, and writes the text and metadata into a persistent storage structure such as a document table or collection.
Server generates, as output, a normalized record containing the document identifier, the stored text, and the stored metadata.

### Step 4

Server performs classical natural language preprocessing.
Server uses, as input, the stored text associated with the document identifier.
Server applies tokenization, sentence segmentation, and part-of-speech tagging using a natural language processing engine, and converts the raw text into token sequences and sentence boundaries.
Server generates, as output, linguistic annotation data including token lists, sentence indices, and grammatical tags linked to the document identifier.

### Step 5

Server extracts phrase information and document-level features.
Server uses, as input, the linguistic annotation data produced in Step 4.
Server computes term statistics such as term frequency and inverse document frequency, selects high-weight terms as candidate key phrases, and, when available, computes dense embedding vectors using a sentence encoder network.
Server generates, as output, a phrase information set (including key phrases and named entities) and at least one feature vector representing the semantic content of the information resource.

### Step 6

Server constructs a prompt sentence for a generative AI model to analyze the information resource.
Server uses, as input, the phrase information, the feature vector, and a text portion (for example, abstract and introduction paragraphs) of the information resource.
Server formats these inputs into a single character string that includes explicit instructions, for example: a description of the analysis task, the text portion, and markers delimiting sections of the prompt.
Server generates, as output, a prompt sentence that is ready for submission to the generative AI model.

### Step 7

Server sends the prompt sentence to the generative AI model and receives an analysis result.
Server uses, as input, the prompt sentence created in Step 6.
Server tokenizes the prompt sentence, transmits token identifiers to the generative AI model over a model interface, and invokes a forward pass of the neural network to compute output token probabilities; the server then decodes the token sequence to reconstruct the textual response.
Server generates, as output, an analysis result that may include a summary, a list of important phrases, and descriptions of citation target types in text form.

### Step 8

Server parses and structures the analysis result.
Server uses, as input, the textual analysis result obtained in Step 7.
Server applies rule-based or pattern-based parsing to detect numbered lists, section headers, or other markers, and maps extracted segments into structured fields such as summary text, keyword arrays, and citation category labels.
Server generates, as output, a structured analysis object that augments the phrase information and feature vectors derived in Step 5.

### Step 9

Server searches a related information set to obtain candidate related information resources.
Server uses, as input, the structured analysis object and the phrase information (for example, key phrases, topics, and citation categories).
Server constructs search queries using the key phrases and topic labels, executes these queries against an internal or external index, and computes an initial similarity score based on lexical and embedding similarity for each retrieved resource.
Server generates, as output, a candidate resource list that includes identifiers, titles, abstracts, and initial similarity values.

### Step 10

Server computes relevance scores for the candidate related information resources.
Server uses, as input, the candidate resource list and the feature vector of the information resource.
Server represents each candidate as a vector in the same feature space as the information resource and calculates a numerical relevance score, for example by computing cosine similarity and scaling the result to a defined range.
Server generates, as output, a candidate list in which each candidate is associated with a relevance score.

### Step 11

Server filters candidates using a predetermined threshold.
Server uses, as input, the candidate list annotated with relevance scores.
Server compares each relevance score to a threshold value stored in a configuration and discards candidates with scores lower than the threshold while retaining higher-scoring candidates.
Server generates, as output, a reduced candidate list that contains only candidates whose relevance scores satisfy the threshold condition.

### Step 12

Server retrieves citation frequency information for the reduced candidate list.
Server uses, as input, the identifiers (for example, titles or resource identifiers) of the candidates in the reduced list.
Server sends batch queries to an external citation database, receives citation counts, and associates each citation count with its corresponding candidate resource; the server may cache these citation counts for future requests.
Server generates, as output, an augmented candidate list in which each candidate has both a relevance score and citation frequency information.

### Step 13

Server computes an evaluation index and ranks candidate resources.
Server uses, as input, the augmented candidate list containing relevance scores and citation data.
Server normalizes the relevance scores and citation frequencies, applies a predetermined weighting function, and computes, for each candidate, an evaluation index representing a combined measure of semantic relevance and citation authority; the server then sorts candidates in descending order of the evaluation index.
Server generates, as output, a ranked candidate list ordered by evaluation index values.

### Step 14

Terminal captures user image and voice information for emotion estimation.
Terminal uses, as input, ongoing sensor outputs from a camera and a microphone while the user is reading the information resource.
Terminal executes an on-device pre-processing algorithm to detect the user's face in image frames, extract facial landmarks, compute basic audio features (for example, energy and pitch), and compress these features into a compact representation.
Terminal generates, as output, an emotion feature packet that contains time-stamped image and voice features and optionally a preliminary emotion estimate.

### Step 15

Terminal transmits the emotion feature packet to the server.
Terminal uses, as input, the emotion feature packet produced in Step 14.
Terminal sends the emotion feature packet to the server using a network message, along with a session identifier and user identifier, so that emotion information can be associated with the active document.
Terminal generates, as output, a network request containing emotion-related data.

### Step 16

Server estimates the user emotional state from multi-modal data.
Server uses, as input, the emotion feature packet and, optionally, user input text or rating data transmitted separately by the terminal.
Server feeds the image features into a trained facial emotion classifier and the audio features into a trained acoustic emotion classifier and processes any text data with a sentiment analysis model; the server then aggregates classifier outputs by computing a weighted average or a probabilistic fusion to produce a final emotion probability vector.
Server generates, as output, a user emotional state representation that assigns values to states such as confusion, excitement, and boredom.

### Step 17

Server adjusts evaluation indices based on the user emotional state.
Server uses, as input, the ranked candidate list from Step 13 and the emotional state representation from Step 16.
Server applies an emotion-dependent weighting function that increases or decreases evaluation indices according to pairs of (emotion, resource type), for example boosting introductory resources when confusion is high; the server recalculates a final score for each candidate by adding the emotion-based adjustment.
Server generates, as output, an emotion-adjusted ranked list of candidate information resources.

### Step 18

Server optionally refines recommendations using the generative AI model with emotion context.
Server uses, as input, the emotion-adjusted ranked list and the user emotional state.
Server builds a new prompt sentence that includes the summary of the information resource, a portion of the ranked list, and explicit instructions that reflect the emotion, for example: “The user is currently confused about the ethical aspects of AI.
Here is the article summary: <<summary>>
Here are candidate references with citations and difficulty levels: <<candidate_list>>
Please select 5 beginner-friendly, highly cited references that will help resolve confusion, and explain each choice in simple language.”
Server sends this prompt sentence to the generative AI model, parses the response to identify a selected subset and associated explanations, and reconciles this subset with the emotion-adjusted scores.
Server generates, as output, a final recommended information resource set with natural-language selection reasons.

### Step 19

Server prepares a response message for the terminal.
Server uses, as input, the final recommended information resource set and selection reason information created in Step 18.
Server packages the recommended items, their metadata (titles, identifiers, citation counts), emotion-adjusted scores, and explanatory text into a structured response format associated with the user session.
Server generates, as output, a response payload ready for transmission to the terminal.

### Step 20

Server transmits the response payload to the terminal.
Server uses, as input, the structured response payload from Step 19 and the network address of the terminal.
Server sends the payload through the communication interface using a response message so that the terminal can receive the recommended information resource set.
Server generates, as output, a network response containing recommendation data.

### Step 21

Terminal displays the recommended information resource set to the user.
Terminal uses, as input, the response payload received from the server.
Terminal parses the payload, constructs user interface elements such as lists and icons, and renders recommended resources on the display along with selection reasons, citation counts, and labels indicating suitability for the user emotional state.
Terminal generates, as output, a visual presentation of the recommended information resource set that the user can view and interact with.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

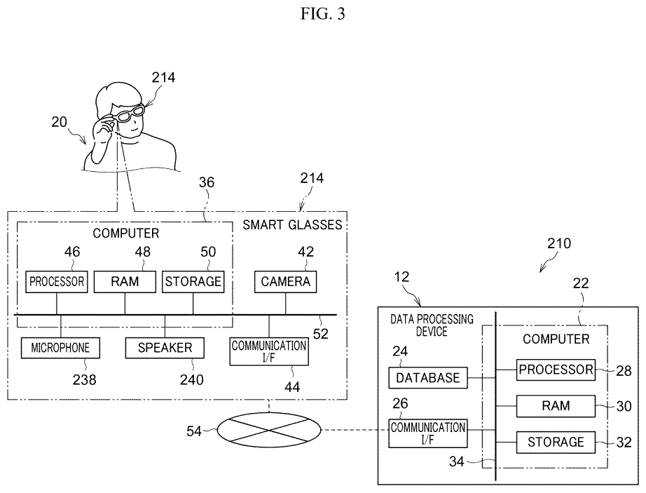

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

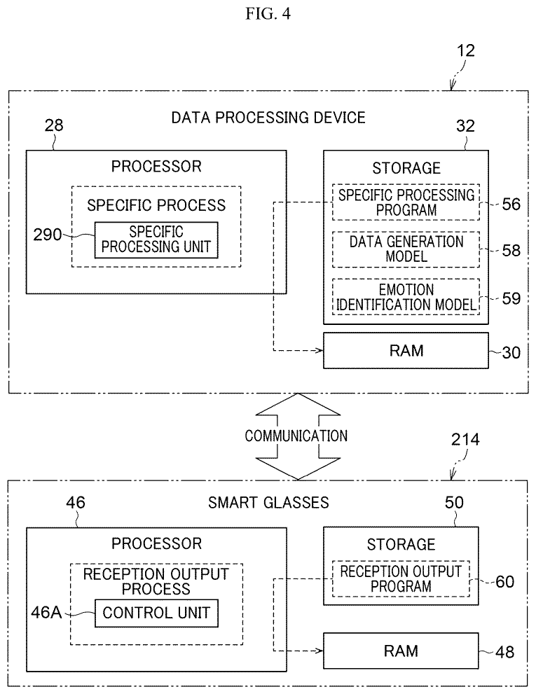

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

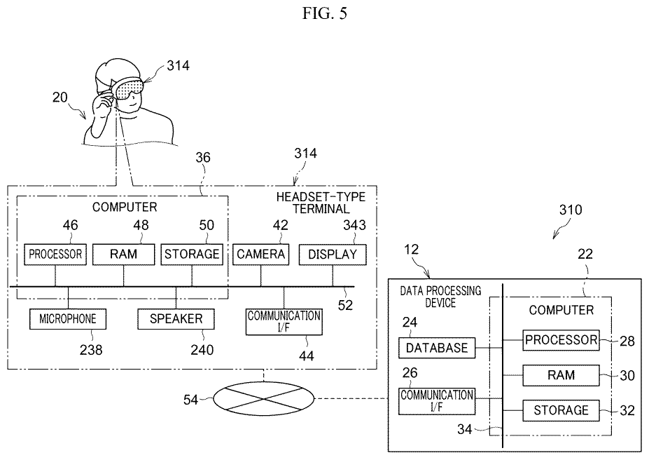

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

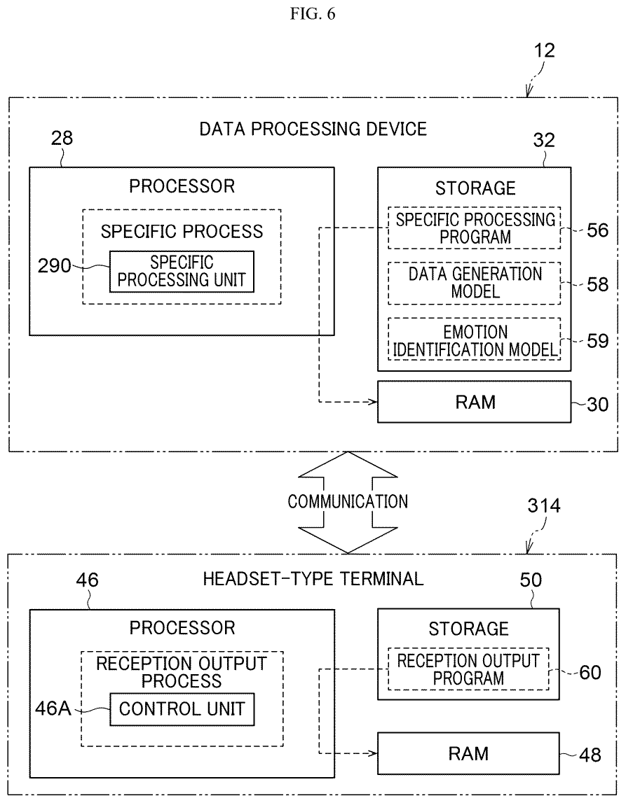

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

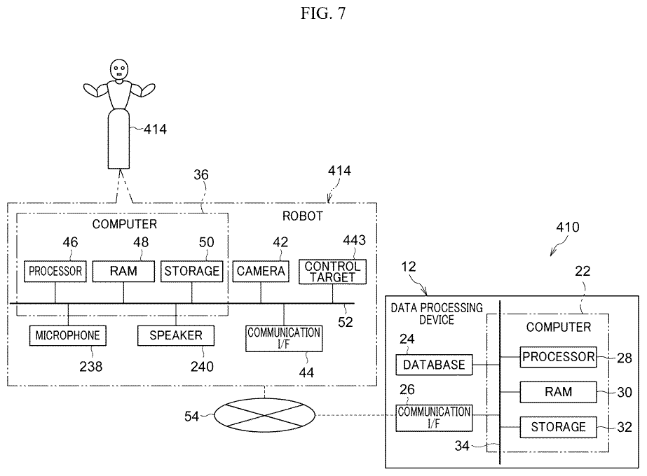

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

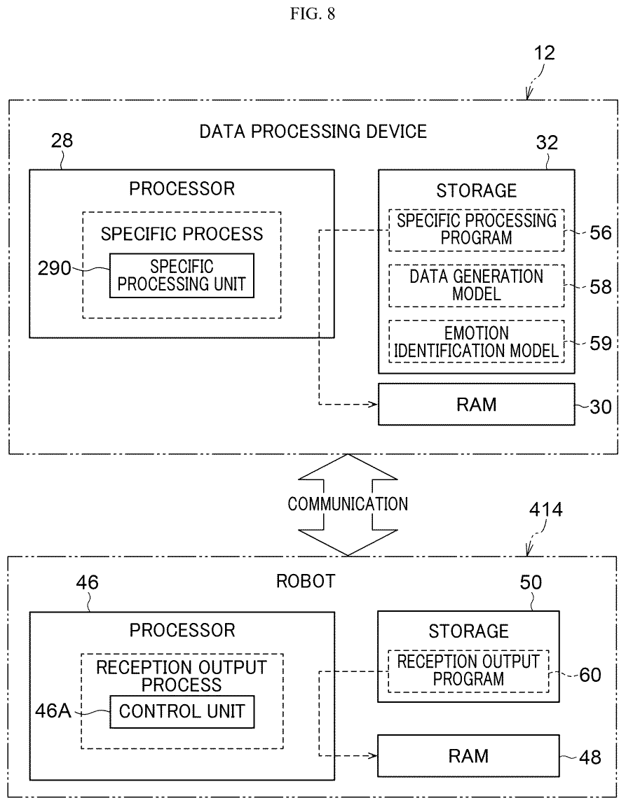

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

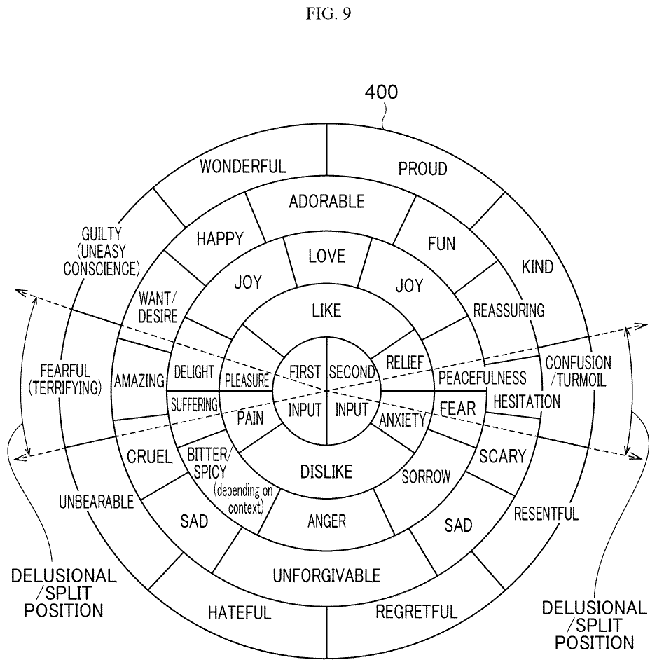

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

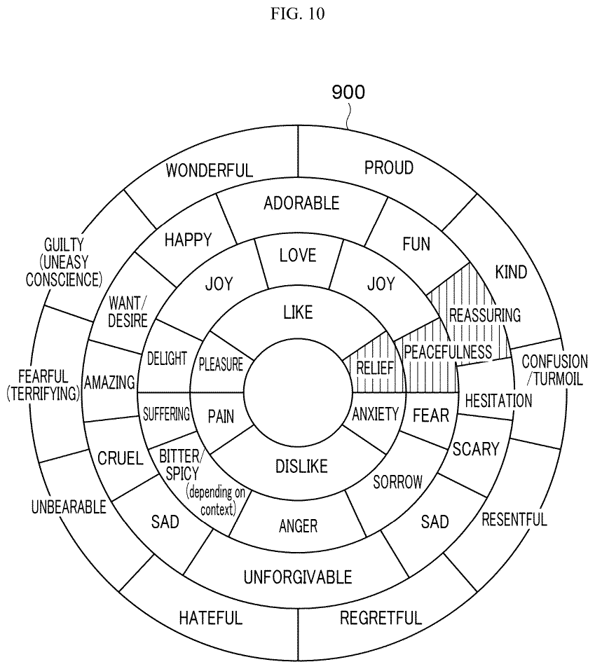

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive document data from a user terminal, determine a format of the document data, convert the document data into character information, and normalize the character information into a standard character code and notation format,
configure the character information as analysis instruction information including a prompt sentence for input to a natural language processing engine and a generative AI model, cause the natural language processing engine to execute word segmentation, part-of-speech assignment, syntactic analysis, and semantic representation generation to produce analysis result data, instruct the generative AI model to perform analysis processing via the prompt sentence, and obtain the analysis result data and response data from the generative AI model, extract topic information, important term information, and context information for an entirety of the document based on the analysis result data and the response data, and generate search conditions and feature vectors corresponding to the topic information and the important term information,
retrieve candidate resources from an information storage device based on the search conditions and the feature vectors, calculate, for each candidate resource, a relevance evaluation value indicating a degree of relevance to content of the document and a usage-frequency evaluation value indicating a degree of usage of the candidate resource, and combine the relevance evaluation value and the usage-frequency evaluation value to obtain a recommendation evaluation value and select, as recommended resources, resources whose recommendation evaluation values are equal to or greater than a predetermined criterion, generate and input to the generative AI model a prompt sentence including the topic information, the important term information, and information on the recommended resources, obtain summary information, explanation information, or additional recommendation information from the generative AI model, associate the obtained information with the recommended resources, and generate output data as a recommendation result, and convert recommended resources and generated information included in the output data into display data for presentation to the user terminal and transmit the display data to the user terminal.

### Supplementary 2

The system according to supplementary 1,
wherein the processor is configured to
calculate the usage-frequency evaluation value as a usage index that is temporally normalized based on at least one of a reference count, an acquisition count, and a viewing time for each resource, and correct the recommendation evaluation value based on the usage index.

### Supplementary 3

The system according to supplementary 1,
wherein the processor is configured to
dynamically generate the prompt sentence to be input to the generative AI model based on the analysis result data produced by the natural language processing engine, resource information acquired from the information storage device, and user attribute information held for each user, and adjust explanation information or selection results of the recommended resources using response contents of the generative AI model to the prompt sentence.

### Application Example 1

### Supplementary 1

A system comprising a processor,
wherein the processor is configured to
receive, from a terminal apparatus, user interest information and a topic input by a user, and acquire, on the basis of a prompt sentence including the topic, document data related to the topic from an external information providing apparatus and an internal information storage apparatus,
extract text data from the acquired document data, input the text data into an analysis information processing mechanism having a natural language processing function, generate, for each piece of the document data, analysis result data including subject information and keyword information, and store the analysis result data in a storage apparatus, generate a prompt sentence that supplies structured data including the topic of the user and the analysis result data to a generative artificial intelligence model, input the prompt sentence and the structured data into the generative artificial intelligence model, and obtain, from the generative artificial intelligence model, generation result data including summary information and relevance-reason information for each piece of the document data,
apply an evaluation function to the analysis result data, the generation result data, citation frequency information, publication time information, and the user interest information, calculate a relevance index for each piece of the document data, and select, as contextually citable reference information, document data for which the relevance index is equal to or greater than a predetermined value,
acquire viewing operation information and selection operation information performed by the user with respect to the reference information presented on the terminal apparatus, update the user interest information on the basis of the operation information, and dynamically change, in accordance with the updated user interest information, the prompt sentence to be input to the generative artificial intelligence model in a subsequent processing and weighting of the evaluation function, and
cause a display apparatus of the terminal apparatus to present the selected reference information and the generation result data to the user.

### Supplementary 2

The system according to supplementary 1,
wherein the processor is configured to
generate list information including, for each piece of the document data related to the topic, title information, abstract information, keyword information, citation frequency information, and publication time information, input structured data including the list information into the generative artificial intelligence model, and obtain, as the generation result data, ranking information of the document data and explanation text information for the ranking.

### Supplementary 3

The system according to supplementary 1,
wherein the processor is configured to
store viewing history information and preference information of the user with respect to the reference information, calculate an interest vector representing an interest field of the user on the basis of the viewing history information and the preference information, and include the interest vector in the prompt sentence to be input to the generative artificial intelligence model so as to adapt the summary information and the relevance-reason information included in the generation result data to the user.

### Example 2

### Supplementary 1

A system comprising a processor,
wherein the processor is configured to
receive a prompt sentence acquired from a user terminal, and input the prompt sentence to a generative AI model as an instruction to perform analysis using natural language processing so as to analyze content of the prompt sentence, and obtain analysis result data including keywords and concepts from the generative AI model,
generate search query data for searching an information source storage based on the keywords and the concepts included in the analysis result data, search the information source storage by using the search query data, and extract a plurality of information source candidate data items,
execute relevance evaluation processing for each of the plurality of information source candidate data items in order to evaluate contextual consistency with the prompt sentence and the analysis result data, and select, as contextually citable information source data, information source candidate data items having a relevance evaluation value that is equal to or greater than a predetermined threshold, and
format the selected information source data into response data displayable by the user terminal, and provide the response data to the user terminal.

### Supplementary 2

The system according to supplementary 1,
wherein the processor is configured to
convert text data of the prompt sentence and the information source candidate data items into embedding vector data, and calculate the relevance evaluation value based on similarity between the embedding vector data.

### Supplementary 3

The system according to supplementary 1,
wherein the processor is configured to
cause the generative AI model to generate summary information of the information source candidate data items based on the prompt sentence, and include the summary information in the response data provided to the user terminal.

### Application Example 2

### Supplementary 1

A system comprising a processor,
wherein the processor is configured to
input a prompt sentence to a generative AI model in order to cause the generative AI model to execute an analysis process using natural language processing on content of a text-based information resource, and obtain an analysis result regarding the information resource from the generative AI model,
obtain candidate related information resources that are contextually citable from a related information set based on the analysis result and phrase information extracted from the information resource, calculate a relevance score for each of the candidate related information resources, and select candidate related information resources whose relevance scores are equal to or greater than a predetermined threshold,
obtain citation frequency information for the selected candidate related information resources from an external information storage, calculate an evaluation index based on the citation frequency information and the relevance scores, and rank the candidate related information resources according to the evaluation index,
estimate a user emotional state based on image information, voice information, or text information acquired from a user terminal,
identify a recommended information resource set suitable for the user emotional state by weighting or correcting the evaluation index or the ranking result according to the user emotional state, and
transmit the recommended information resource set and selection reason information to the user terminal so that the recommended information resource set is displayed on the user terminal.

### Supplementary 2

The system according to supplementary 1,
wherein the processor is configured to generate the prompt sentence including at least a part or a summary of the information resource and an analysis request related to the information resource, and input the prompt sentence to the generative AI model in order to obtain the analysis result including summary information, important phrase information, and information on types of citation targets.

### Supplementary 3

The system according to supplementary 1,
wherein the processor is configured to calculate the evaluation index by integrating a numerical index based on the relevance scores and the citation frequency information with a ranking result obtained by inputting to the generative AI model a prompt sentence including a list of the candidate related information resources, summary information related to the information resource, and recommendation conditions, and to modify the evaluation index according to the user emotional state in order to generate, as the recommended information resource set, a dynamically updated information resource set corresponding to a reading situation of the user.

What is claimed is:

1. A system comprising:
circuitry configured to:
receive, via a communication interface coupled to a packet-switched network, document data including contents of a paper from a terminal device, and store the document data in a storage device;
input a prompt sentence to a generative AI model to instruct the generative AI model to perform an analysis of the contents of the paper using natural language processing techniques, and obtain an analysis result generated by the generative AI model;
calculate a relevance score for each of a plurality of references stored in the storage device based on the analysis result, and select, as contextually citable references, references having a relevance score equal to or greater than a predetermined threshold; and
recognize an emotion of a user based on user state data received via the communication interface, adjust the analysis result based on the recognized emotion, and transmit adjusted recommendation output to the terminal device via the communication interface.

2. The system according to claim 1, wherein the circuitry is configured to determine a format of the document data, convert the document data into normalized character information, and configure the character information as analysis instruction information including a prompt sentence for input to both a natural language processing engine and the generative AI model.

3. The system according to claim 2, wherein the circuitry is configured to invoke the natural language processing engine to execute word segmentation, part-of-speech assignment, syntactic analysis, and semantic representation generation to produce machine-readable analysis result data, and integrate the analysis result data with response data from the generative AI model.

4. The system according to claim 3, wherein the circuitry is configured to extract topic information, important term information, and context information from the integrated analysis result data, and generate search conditions and feature vectors suitable for use by a search and retrieval subsystem.

5. The system according to claim 4, wherein the circuitry is configured to retrieve candidate resources from the storage device based on the search conditions and the feature vectors, and calculate, for each candidate resource, a relevance evaluation value indicating a degree of semantic relevance to content of the document.

6. The system according to claim 5, wherein the circuitry is configured to calculate a usage-frequency evaluation value for each candidate resource as a temporally normalized usage index based on at least one of reference count, acquisition count, and viewing time, and combine the relevance evaluation value and the usage-frequency evaluation value to obtain a recommendation evaluation value.

7. The system according to claim 6, wherein the circuitry is configured to dynamically generate a prompt sentence including at least the topic information, the important term information, and information on recommended resources selected based on the recommendation evaluation value, transmit the prompt sentence to the generative AI model, and receive summary information, explanation information, or additional recommendation information from the generative AI model.

8. The system according to claim 1, wherein the circuitry is configured to modify at least one of a threshold for relevance score filtering, a presentation style of analysis results, or an emphasis on particular references based on the recognized emotion of the user.

9. The system according to claim 8, wherein the circuitry is configured to recognize an emotional state of the user indicating frustration, uncertainty, or confidence from the user state data, and adapt the adjustment of the analysis result to the recognized emotional state.

10. The system according to claim 1, wherein the circuitry is configured to generate output data including structured recommendation results associating the recommended references with summary information and explanation information, and transmit the output data as display data to the terminal device via the communication interface.

11. The system according to claim 1, wherein the circuitry is configured to receive user attribute information from the terminal device via the communication interface, and incorporate the user attribute information into a prompt sentence generated for the generative AI model to personalize the analysis result.

12. The system according to claim 1, wherein the circuitry is configured to generate a second prompt sentence that includes topic information, important term information, and information on recommended references, and transmit the second prompt sentence to the generative AI model to obtain additional commentary on the contextual relevance of the selected references.

13. The system according to claim 1, wherein the circuitry is configured to calculate a relevance score for each reference by computing a semantic similarity between a vector representation of the analysis result and a vector representation of the reference, and apply the predetermined threshold to the computed similarity scores.

14. The system according to claim 1, wherein the circuitry is configured to store, in the storage device, records of references selected as contextually citable for a user in association with user identifiers, and use the stored records to personalize subsequent analysis results for the user.

15. The system according to claim 1, wherein the circuitry is configured to receive, from the terminal device, feedback indicating whether selected references were useful to the user, update the predetermined threshold based on the feedback, and refine relevance score calculations for subsequent document analyses.

16. The system according to claim 1, wherein the circuitry is configured to invoke the natural language processing engine and the generative AI model in parallel for a received document, and merge outputs from both to produce a consolidated set of topic information and contextual representations.

17. The system according to claim 16, wherein the circuitry is configured to generate a ranked list of references ordered by recommendation evaluation value, and transmit the ranked list to the terminal device for display in a format enabling the user to select references for citation.

18. A system comprising:
circuitry configured to:
receive, via a communication interface coupled to a packet-switched network, document data from a terminal device and store the document data in a storage device;
convert the document data into normalized character information, input a prompt sentence incorporating the character information to a generative AI model, and obtain an analysis result including topic information and context information generated by the generative AI model;
calculate a relevance evaluation value and a usage-frequency evaluation value for each of a plurality of candidate references retrieved from the storage device based on the analysis result, combine the evaluation values to obtain a recommendation evaluation value, and select recommended references based on the recommendation evaluation value; and
recognize an emotion of a user based on data received from the terminal device via the communication interface, adjust the analysis result based on the recognized emotion, and transmit recommendation output including the selected references to the terminal device via the communication interface.

19. The system according to claim 18, wherein the circuitry is configured to generate a prompt sentence incorporating the topic information, the context information, and information on the selected recommended references, transmit the prompt sentence to the generative AI model, and receive summary information or explanation information from the generative AI model for association with the recommended references.

20. A method comprising:
receiving, via a communication interface coupled to a packet-switched network, document data including contents of a paper from a terminal device, and storing the document data in a storage device;
inputting a prompt sentence to a generative AI model to instruct the generative AI model to perform an analysis of the contents of the paper using natural language processing techniques, and obtaining an analysis result generated by the generative AI model;
calculating a relevance score for each of a plurality of references stored in the storage device based on the analysis result, and selecting, as contextually citable references, references having a relevance score equal to or greater than a predetermined threshold; and
recognizing an emotion of a user based on user state data received via the communication interface, adjusting the analysis result based on the recognized emotion, and transmitting adjusted recommendation output to the terminal device via the communication interface.
